(19) United States
(12) Patent Application Publication
(10) Pub. No.: US 2026/0046249 A1
(43) Pub. Date: Feb. 12, 2026

(54) SYSTEMS AND METHODS FOR DATA FORWARDING AND DATA PROCESSING

(71) Applicant: Huawei Technologies Co., Ltd., Shenzhen (CN)

(72) Inventors: Chenchen Yang, Ottawa (CA); Xu Li, Nepean (CA); Weisen Shi, Ottawa (CA)

(21) Appl. No.: 19/365,739

(22) Filed: Oct. 22, 2025

Related U.S. Application Data
(63) Continuation of application No. PCT/CN2023/090021, filed on Apr. 23, 2023.

(51) Int. Cl. H04L 45/745; H04L 45/00; H04L 47/34; H04L 69/22

(52) U.S. Cl. CPC H04L 45/745; H04L 45/20; H04L 47/34; H04L 69/22

(57) ABSTRACT

The disclosure provides for systems and methods for data forwarding and data processing. According to an aspect a method is provided. The method may include receiving, from a control plane function, packet header configuration information. including a plurality of forwarding table identifiers (FTIDs) associated with a respective plurality of forwarding tables (FTs). Each FT of the plurality of FTs may define a path to be followed by the processing data when the communication network provides the network service. The plurality of FTs may define a sequence of paths to be followed by the processing data. The method may further include encapsulating into a header of a packet, configured packet header information based on the packet header configuration information. The method may further include sending, to a second PF of the PPFs, the packet in accordance with a first FT of the plurality of FTs.

### CROSS-REFERENCE TO RELATED APPLICATIONS

This application is a continuation of International Application No. PCT/CN2023/090021, filed on Apr. 23, 2023, the disclosure of which is hereby incorporated by reference in its entirety.

### TECHNICAL FIELD

The present disclosure pertains to the field of communication networks, and in particular to systems and methods for data forwarding and data processing.

### BACKGROUND

Future networks may operate based in part on mission management concept. Under this concept, data may be forwarded according to a mission, which may involve multiple data paths (e.g., for data aggregation purposes) and loop transmissions. However, existing technologies for data forwarding, such as Bit Indexed Explicit Replication (BIER), prevent formation of loop transmission. Further, existing technologies may prevent one node from receiving packets from different upstream nodes, thereby preventing duplicated packets being transmitted to a same node. In addition to said limitations, existing technologies may have limited or weak scalability in terms of data processing configuration, which may further render such technologies in inadequate for future networks.

Therefore, there is a need for systems and methods for data forwarding and data processing that obviates or mitigates one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

The disclosure provides for systems and methods for data plane architecture of a wireless communication system. According to an aspect a method is provided for data forwarding and data processing by a control plane function. The method includes sending, by the control plane function to each of a plurality of processing functions (PPFs), configuration information for one or more forwarding tables (FTs). Each of the one or more FTs may have a FT identifier (ID), and the PPFs may define a directed graph having a plurality of vertices and a plurality of directed edges. Each vertex of the plurality of vertices may correspond to a respective PF of the PPFs, and each directed edge of the plurality of directed edges may correspond to a hop of a path to be followed by processing data between a respective pair of PFs of the PPFs. The directed graph and the PPFs may be associated with a network service provided by a communication network. The configuration information for each forwarding table may include path information defining at least one path to be followed by the processing data between the PF at which the configuration data is received and another one or more PFs of the PPFs.

The method may further include sending, by the control plane function to a first PF of the PPFs, packet header configuration information. The packet header configuration information may include a plurality of FTIDs defining a sequence of the paths to be followed by the processing data when the communication network provides the network service. Each FTID of the plurality of FTIDs may be associated with a respective one of the one or more FTs.

The path information may include neighbor PF data defining one or more next-hop PFs for the PF at which the configuration data is received. The path information may further include forwarding bit mask (FBM) data associated with each neighbor node indicating a set of leaf nodes of the PPFs to be reached by the processing data via said each neighbor node, the set of leaf nodes associated with the path corresponding to said each forwarding table.

The packet header configuration information may further include a plurality of time to live values (TTLVs) corresponding to the plurality of forwarding table IDs. Each TTLV of the plurality of TTLVs may correspond to a respective FTID of the plurality of FTIDs and indicate a number of hops remaining for the packet to reach a destination of the path. The packet header configuration information may further include a plurality of source node IDs corresponding to the plurality of forwarding table IDs. Each source node ID may correspond to a forwarding table ID and its associated data path. Each source node ID may further indicate a source node for initiating the associated data path.

The packet header configuration information may further include a plurality of bitstrings, each bitstring corresponding to a forwarding table ID and indicating one or more leaf PFs of a data path associated with the corresponding forwarding table ID. The packet header configuration information may further include a plurality of bitstring lengths (BSLs) corresponding to the plurality of bitstrings. Each BSL may define a length of a respective bitstring of the plurality of bitstrings and each BSL may correspond to a respective FTID.

The packer header configuration information may further include one or more functions IDs identifying one or more functions to be performed by one or more PFs of the plurality of PFs. The method may further include assigning, by the control plane function, to each PF that is a leaf PF of a data path, a bitstring indicating said each PF is the leaf PF.

According to another aspect, another method is provided for data forwarding and data processing by a source node. The method may be performed by a first processing function (PF) of a plurality of processing functions (PPFs). The PPFs may define a directed graph having a plurality of vertices and a plurality of directed edges. Each vertex of the plurality of vertices may correspond to a respective PF of the PPFs, and each directed edge of the plurality of edges corresponding to a hop of a path to be followed by processing data between a respective pair of PFs of the PPFs. The directed graph and the PPFs may be associated with a network service provided by a communication network.

The method includes receiving, from a control plane function, packet header configuration information. The packet header configuration information may include a plurality of forwarding table identifiers (FTIDs) associated with a respective plurality of forwarding tables (FTs). Each FT of the plurality of FTs may define a path to be followed by the processing data when the communication network provides the network service. The plurality of FTs may define a sequence of paths to be followed by the processing data.

The method may further include encapsulating, by the first PF, into a header of a packet, configured packet header information based on the packet header configuration information. The method may further include sending, by the first PF to a second PF of the PPFs, the packet in accordance with a first FT of the plurality of FTs.

The packet header configuration information may further include a plurality of time to live values (TTLVs) corresponding to the plurality of FTIDs. Each TTLV of the plurality of TTLVs may correspond to a respective FTID of the plurality of FTIDs and indicate a number of hops remaining for the packet to reach a destination of the path. The packet header configuration information may further include a plurality of source node IDs corresponding to the plurality of forwarding table IDs. Each source node ID may identify a PF of the PPFs and correspond to a respective FTID and its associated data path. Each source node ID may further indicate a source node for initiating the associated data path.

The packet header configuration information may further include a plurality of bitstrings corresponding to the plurality of FTIDs. Each bitstring may correspond to a respective FTID and indicate one or more leaf PFs of a data path associated with the corresponding FTID. The packet header configuration information may further include a plurality of bitstring lengths (BSLs) corresponding to the plurality of bitstrings. Each BSL may define a length of a respective bitstring of the plurality of bitstrings and each BSL may correspond to a respective FTID.

The method may further include receiving, by the first PF from the control plane function, configuration information for one or more FTs of the plurality of FTs including the first FT. The configuration information for each of the one or more FTs may include neighbor PF data defining one or more next-hop PFs for the PF at which the configuration data is received. The configuration information for each of the one or more FTs may further include forwarding bit mask (FBM) data associated with each neighbor node indicating a set of leaf nodes of the PPFs to be reached by the processing data via said each neighbor node. The set of leaf nodes associated with the path may correspond to said each of the one or more FTs.

The second PF may be a neighbor PF indicated by the configuration data of the first FT. The configured packet header information may include a result of a bitwise AND (&) operation. The result of a bitwise AND (&) operation may be based on a first bitstring of the plurality of bitstrings corresponding to the first forwarding table. The result of a bitwise AND (&) operation may further be based FBM data of the first forwarding table and associated with the neighbor node. The result of a bitwise AND (&) operation may further be based an updated TTLV corresponding to the first FT. The result of a bitwise AND (&) operation may further be based the plurality of source node IDs.

The packet header configuration information may further indicate a first set of functions IDs identifying a first set of functions to be performed by one or more PFs of the PPFs including the first PF. The first set of function IDs may be arranged according to the sequence of paths to be followed by the processing data. The method may further include processing, by the first PF, the processing data according to one or more functions of the first set of functions to obtain results, the one or more functions being associated with the first PF and with a first FT.

The configured packet header information may further include a second set of function IDs identifying a second set of functions to be performed by the one or more PFs of the PPFs. The second set of functions may include the first set of functions and exclude the one or more functions being associated with the first PF and with the first FT.

The method may further include encapsulating, by the first PF into a payload of the packet, the results. Sending, by the first PF to the second PF, the packet based on a first forwarding FT indicated by the sequence of paths may include sending the packet including the payload.

According to another aspect, another method is provided for data forwarding and data processing by an intermediate node. The method incudes receiving, by a first processing function (PF) from a second PF, a packet including a packet header, the packer header including a first configured packet header information. The first configured packet header information may include a plurality of forwarding table identifiers (IDs) corresponding to and indicating a data forwarding sequence of a plurality of data paths of a mission associated with one or more services. The plurality of forwarding table IDs identifies a plurality of forwarding tables, where each forwarding table corresponds to a data path of the plurality of data paths. Each data path may be based on a directed graph of the mission. The method may further include encapsulating, by the first PF into the packet header, a second configured packet header information based on the first configured packet header information. The method may further include sending, by the first PF to a third PF, the packet based on a first forwarding table indicated by the data forwarding sequence.

The first configured packet header information may further indicate a plurality of time to live values (TTLVs) corresponding to the plurality of forwarding table IDs. Each TTLV may correspond to a forwarding table ID and indicate a number of hops remaining for the packet to reach a destination of the path. The first configured packet header information may further indicate a plurality of source node IDs corresponding to the plurality of forwarding table IDs. Each source node ID may correspond to a forwarding table ID and its associated data path. Each source node ID may further indicate a source node for initiating the associated data path.

The first configured packet header information may further indicate a plurality of bitstrings corresponding to the plurality of forwarding table IDs. Each bitstring may correspond to a forwarding table ID and indicate one or more leaf nodes of a data path associated with the corresponding forwarding table ID. The first configured packet header information may further indicate a plurality of bitstring lengths (BSLs) corresponding to the plurality of bitstrings. Each BSL may define a length of a respective bitstring of the plurality of bitstrings and each BSL may correspond to a respective FTID.

The method may further include receiving, by the first PF from a control plane function, configuration information for one or more forwarding tables of the plurality of forwarding tables including the first forwarding table. The configuration information for each of the one or more forwarding tables may include one or more neighbor nodes for a next hop. The configuration information for each of the one or more forwarding tables may further include forwarding bit mask (FBM) information associated with each neighbor node indicating a set of leaf nodes that can be reached via said each neighbor node, the set of leaf nodes associated with a data path corresponding to said each forwarding table.

The third PF may be a neighbor node indicated by the configuration information of the first forwarding table. The second configured header information may include a result of a bitwise AND (&) operation. The result of a bitwise AND (&) operation may be based on a first bitstring of the plurality of bitstrings corresponding to the first forwarding table. The result of a bitwise AND (&) operation may be further based on an FBM information of the first forwarding table and associated with the neighbor node.

The second configured header information may further include an updated TTL value corresponding to the first forwarding table. The second configured header information may further include the plurality of source node IDs.

The first packet header configuration information may further indicate a first set of functions IDs identifying a first set of functions to be performed by one or more PFs of a plurality of PFs including the first PF. The first set of function IDs may be arranged according to the data forwarding sequence. The method may further include processing, by the first PF, data according to one or more functions of the first set of functions to obtain results, the one or more functions associated with the first PF and a first forwarding table.

The second configured packet header information may further include a second set of function IDs identifying a second set of functions to be performed by the one or more PFs. The second set of functions may include the first set of functions and exclude the one or more functions associated with the first PF and a first forwarding table.

The method may further include encapsulating, by the first PF into a payload of the packet, the results. Sending, by the first PF to a third PF, the packet based on a first forwarding table indicated by the data forwarding sequence may include sending the packet including the payload.

According to another aspect, another method is provided for data forwarding and data processing by a leaf node. The method includes receiving, by a first processing function (PF) from a second PF, a packet according to a first forwarding table of a plurality of forwarding tables and a data forwarding sequence. The packet may include a packet header, the packet header further including a first configured packet header information. The first configured packet header information may include a plurality of forwarding table identifiers (IDs) corresponding to and indicating the data forwarding sequence of a plurality of data paths of a mission associated with one or more services. The plurality of forwarding table IDs identifying the plurality of forwarding tables including the first forwarding table. Each forwarding table corresponding to a data path of the plurality of data paths, and each data path being based on a directed graph of the mission. The method may further include processing, by the first PF, data according to the first configured packet header information.

The first configured packet header information may further indicate a plurality of time to live (TTL) values corresponding to the plurality of forwarding table IDs. Each TTL value may correspond to a forwarding table ID and indicate a number of hops remaining for the packet to reach a destination of the path. The first configured packet header information may further indicate a first TTL value of the plurality of TTL values corresponding to the first forwarding table indicating that the packet has completed its last hop according to a data path corresponding to the first forwarding table.

The first configured packet header information may further indicate a plurality of bitstrings corresponding to the plurality of forwarding table IDs. Each bitstring may correspond to a forwarding table ID and indicate one or more leaf nodes of a data path associated with the corresponding forwarding table ID. The first configured packet header information may further indicate a first bitstring of the plurality of bitstrings corresponding to the first forwarding table indicating the first PF as a leaf node of the data path corresponding to the first forwarding table.

The first configured packet header information may further indicate a plurality of source node IDs corresponding to the plurality of forwarding table IDs. Each source node ID may correspond to a forwarding table ID and its associated data path, and indicate a source node for initiating the associated data path. The first configured packet header information may further indicate a first source node ID of the plurality of source node IDs corresponding to the first forwarding table.

The first configured packet header information may further indicate a second source node ID of the plurality of source node IDs corresponding to a second forwarding table of the plurality of forwarding tables. The second forwarding table may be a next forwarding table after the first forwarding table according to the data forwarding sequence. The second source node ID may identify the first PF as a source node of a second data path associated with second forwarding table.

The first configured packet header information may further indicate a first set of functions IDs identifying a first set of functions to be performed by one or more PFs of a plurality of PFs including the first PF, the first set of function IDs arranged according to the data forwarding sequence. Processing, by the first PF, data according to the first configured packet header information may include processing, by the first PF, the data according to one or more functions of the first set of functions to obtain a first result, the one or more functions associated with the first PF and a first forwarding table.

The method may further include encapsulating, by the first PF into the packet of the packet, a second configured packet header information based on the first configured packet header information. The method may further include sending, by the first PF to a third PF, the packet according to the second data path associated with the second forwarding table.

The method may further include receiving, by the first PF from the control plane function, configuration information for one or more forwarding tables of the plurality of forwarding tables including the second forwarding table. The configuration information for each of the one or more forwarding tables may include one or more neighbor nodes for a next hop. The configuration information for each of the one or more forwarding tables may further include forwarding bit mask (FBM) information associated with each neighbor node indicating a set of leaf nodes that can be reached via said each neighbor node, the set of leaf nodes associated with a data path corresponding to said each forwarding table.

The third PF may be a neighbor node indicated by the configuration information of the second forwarding table. The second configured packet header information may include a result of a bitwise AND (&) operation. The result of a bitwise AND (&) operation may be based on a second bitstring of the plurality of bitstrings corresponding to the second forwarding table. The result of a bitwise AND (&) operation may further be based on an FBM information of the second forwarding table and associated with the neighbor node. The second configured packet header information may further include a updated TTL value corresponding to the second forwarding table. The second configured packet header information may further include the second source node ID. The second configured packet header information may exclude one or more of: the first TTL value, the first bitstring, the first source ID.

The method may further include further processing, by the first PF, the data according to one or more functions of the first set of functions to obtain a second result, the one or more functions associated with the first PF and the second forwarding table. The second configured packet header information may include a second set of function IDs identifying a second set of functions to be performed by one or more PFs. The second set of functions may include the first set of functions and exclude the one or more functions associated with the first PF and the first forwarding table. The second set of function may further exclude the one or more functions associated with the first PF and the second forwarding table.

The method may further include encapsulating, by the first PF into a payload of the packet, one or more of: the first result and the second result. Sending, by the first PF to the third PF, the packet according to the second data path associated with the second forwarding table may include sending the packet including the payload.

According to another aspect, another method is provided for transmitting an enhanced packet in executing a mission. The method may be performed by a PF of a plurality of PFs involved in a mission. The method includes sending, by a first processing function (PF) of a plurality of PFs to a second PF of the plurality of PFs, a packet including a packet header, where the packet header includes packet header information. The packet header information may indicate a plurality of forwarding table identifiers (IDs) corresponding to and indicating a data forwarding sequence of a plurality of data paths of a mission associated with one or more services. The plurality of forwarding table IDs may identify a plurality of forwarding tables, where each forwarding table may correspond to a data path of the plurality of data paths, and each data path may be based on a directed graph of the mission.

The packet header information may further indicate a plurality of time to live (TTL) values corresponding to the plurality of forwarding table IDs. Each TTL value may correspond to a forwarding table ID and indicate a number of hops remaining for the packet to reach a destination of the path. The packet header information may further indicate a plurality of source node IDs corresponding to the plurality of forwarding table IDs. Each source node ID may correspond to a forwarding table ID and its associated data path. Each source node ID may further indicate a source node for initiating the associated data path.

The packet header information may further indicate a plurality of bitstrings corresponding to the plurality of forwarding table IDs. Each bitstring may correspond to a forwarding table ID and indicate one or more leaf nodes of a data path associated with the corresponding forwarding table ID. The packet header information may further indicate a plurality of bitstring lengths (BSLs) corresponding to the plurality of bitstrings. Each BSL may define a length of a respective bitstring of the plurality of bitstrings and each BSL corresponding to a forwarding table ID.

The packet header information may further indicate a first set of functions IDs identifying a first set of functions to be performed by one or more PFs of the plurality of PFs, the first set of function IDs arranged according to the data forwarding sequence.

According to another aspect, another method is provided for data forwarding and data processing by a control plane function. The method includes sending, by a control plane function to a first processing function (PF) of a first set of PFs, a first packet header configuration information. The first packet header configuration information may indicate a first set of functions to be performed by one or more PFs of the first set of PFs. The first packet header configuration information may further indicate a first forwarding table identifier (ID) identifying a first forwarding table for a first data path. The method may further include sending, by the control plane function to a second PF of the first set of PFs, a second packet header configuration information. The second packet header configuration information may indicate a second set of functions to be performed by one or more PFs of a second set of PFs. The second packet header configuration information may further indicate a second forwarding table identifier (ID) identifying a second forwarding table for a second data path.

The second packet header configuration information may further indicate a switch instruction indicating the second PF to initiate the second data path. The indication to initiate the second data path may be based on receiving an indicator in a received packet, the indicator indicating a completion of the packet's last hop of the first data path.

The switch instruction may include a first source node ID identifying a source node for initiating the first data path according to the first forwarding table. The switch instruction may further include the first forwarding table ID identifying the first forwarding table. The indication to initiate the second data path may be based on receiving a packet having a packet header. The packet header may include an indicator indicating a completion of the packet's last hop of the first data path. The packet header may further include the first source node ID. The packet header may further include the first forwarding table ID.

The first packet header configuration information may further include a query indication. The query indication may indicate that a leaf node of the first data path should send a query message to the control plane function requesting for further instructions when the leaf node receives a packet including a packet header indicating one or more of the following. The packet header may indicate an indicator indicating a completion of a packet's last hop of the first data path. The packet header may further indicate a source node ID identifying the leaf node as a second source node for initiating the second data path.

Where the second PF is the leaf node of the first data path, the method may further include receiving, by the control plane function from the second PF, the query message. The second packet header confirmation information may be in response to the query message.

The method may further include sending, by the control plane function to each of the first set of PFs, configuration information for one or more forwarding tables. Each forwarding table may be associated with an identifier (ID). The configuration information for each forwarding table may indicate information for forwarding data according to a data path based on a directed graph of a mission associated with one or more services. The information for forwarding data may include one or more neighbor nodes for a next-hop from said each PF. The information for forwarding data may further include forwarding bit mask (FBM) information indicating a set of leaf nodes associated with the data path that can be reached via said each neighbor node.

According to another aspect, another method is provided for data forwarding and data processing by a source node. The method includes receiving, by a first processing function (PF) from a control plane function, a packet header configuration information. The packet header configuration information may indicate a set of functions to be performed by one or more PFs. The packet header configuration information may further indicate a forwarding table identifier (ID) identifying a forwarding table for a data path. The method may further include encapsulating, by the first PF into a packet header of a packet, configured packet header information based on the packet header configuration information. The method may further include sending, by the first PF to a second PF, the packet based on the forwarding table.

The packet header configuration information may further indicate a time to live (TTL) value corresponding to the data path, the TTL value indicating a number of hops remaining for the packet to reach a destination of the data path. The packet header configuration information may further indicate a source node ID corresponding to the forwarding table, the source node ID identifying the first PF as a source node for initiating the data path. The packet header configuration information may further indicate a bitstring indicating one or more leaf node of the data path.

The method may further include receiving, by the first PF from the control plane function, configuration information for the forwarding table. The configuration information for the forwarding table may include one or more neighbor nodes for a next-hop. The configuration information for the forwarding table may further include forwarding bit mask (FBM) information associated with each neighbor node indicating a set of leaf nodes that can be reached via said each neighbor node, the set of leaf nodes associated with the data path.

The second PF may be a neighbor node indicated by the configuration information of the forwarding table. The configured packet header information may include a result of a bitwise AND (&) operation. The result of a bitwise AND (&) operation may be based on the bitstring. The result of a bitwise AND (&) operation may further be based on an FBM information of the forwarding table and associated with the neighbor node. The configured packet header information may further include an updated TTL value based on the TTL value. The configured packet header information may further include the source node ID.

The packet header configuration information may further indicate a query indication. The query indication may indicate that a leaf node of the data path should send a query message to the control plane function requesting for further instructions when the leaf node receives the packet. The packet includes the packet header which may indicate the TTL indicating a completion of the packet's last hop of the first data path. The packet header may further indicate a second source node ID identifying the leaf node as a second source node for initiating a second data path.

The packet header configuration information may further indicate the second source node ID. The configured packet header information may further indicate the query indication and the second source node ID.

The method may further include processing, by the first PF, data according to one or more functions of the set of functions to obtain results, the one or more functions associated with the first PF. The configured packet header information may further indicate a second set of function to be performed by the one or more PFs, the second set of functions including the first set of functions and excluding the one or more functions associated with the first PF.

The method may further include encapsulating, by the first PF into a payload of the packet, the results, wherein sending, by the first PF to the second PF, the packet based on the forwarding table includes sending the packet including the payload.

According to another aspect, another method is provided for data forwarding and data processing by an intermediate node. The method includes receiving, by a first processing function (PF) from a second PF, a packet including a packet header, the packet header including a first configured packet header information. The first configured packet header information may indicate a set of functions to be performed by one or more PFs. The first configured packet header information may further indicate a forwarding table identifier (ID) identifying a forwarding table for a data path. The method may further include encapsulating, by the first PF into the packet header, a second configured packet header information based on the first configured packet header information. The method may further include sending, by the first PF to a third PF, the packet based on the forwarding table.

The first configured packet header information may further indicate a time to live (TTL) value corresponding to the data path, the TTL value indicating a number of hops remaining for the packet to perform to reach a destination of the data path. The first configured packet header information may further indicate a bitstring indicating one or more leaf node of the data path.

The method may further include receiving, by the first PF from a control plane function, configuration information for the forwarding table. The configuration information for the forwarding table may include one or more neighbor nodes for a next hop. The configuration information for the forwarding table may further include forwarding bit mask (FBM) information associated with each neighbor node indicating a set of leaf nodes that can be reached via said each neighbor node, the set of leaf nodes associated with the data path.

The second PF may be a neighbor node indicated by the configuration information of the forwarding table. The second configured packet header information may include a result of a bitwise AND (&) operation. The result of a bitwise AND (&) operation may be based on the bitstring. The result of a bitwise AND (&) operation may further be based on an FBM information of the forwarding table and associated with the neighbor node. The second configured packet header information may further include an updated TTL value based on the TTL value.

The first packet header configuration information may further indicate a query indication. The query indication may indicate that a leaf node of the data path should send a query message to a control plane function requesting for further instructions when the leaf node receives the packet including the packet header. The packet header may include the TTL indicating a completion of the packet's last hop of the data path. The packet header may further include a second source node ID identifying the leaf node as a second source node for initiating a second data path.

The first packet header configuration information may further indicate the second source node ID. The second packet header configuration information may further indicate the query indication, and the second source node ID.

The method may further include processing, by the first PF, data according to one or more functions of the set of functions to obtain results, the one or more functions associated with the first PF. The method may further include encapsulating, by the first PF into a payload of the packet, the results, wherein sending, by the first PF to the second PF, the packet based on the forwarding table includes sending the packet including the payload.

According to another aspect, another method is provided for data forwarding and data processing by a leaf node. The method includes receiving, by a first processing function (PF) from a second PF, a packet including a packet header, the packet header including a first configured packet header information. The first configured packet header information may include a first set of functions to be performed by one or more PFs of a first set of PFs. The first configured packet header information may further include a first forwarding table identifier (ID) identifying a first forwarding table for a first data path. The method may further include processing, by the first PF, data according to one or more functions of the first set of functions to obtain a first result, the one or more functions associated with the first PF.

The first configured packet header information may further indicate a first indicator corresponding to the first data path and indicating a completion of the packet's last hop of the first data path. The first configured packet header information may further indicate a first source node ID identifying a first source node for initiating the first data path. The first configured packet header information may further indicate a bitstring indicating one or more leaf node of the first data path.

The method may further include receiving, by the first PF from a control plane function, a packet header configuration information. The packet header configuration information may include a second forwarding table identifier (ID) identifying a second forwarding table for a second data path. The packet header configuration information may further include a second bitstring indicating one or more leaf nodes of the second data path. The packet header configuration information may further include a second source node ID identifying a second source node for initiating the second data path. The packet header configuration information may further include a second indicator indicating a number of hops remaining for the packet to perform to reach a destination of the second data path.

The packet header configuration information further indicates a switch instruction. The switch instruction may indicate the first PF to initiate the second data path. The switch instruction indicating to initiate the second data path may be based on the first indicator indicating a completion of the packet's last hop of the first data path. The switch instruction indicating to initiate the second data path may further be based on the bitstring indicating the first PF as a leaf node of the first data path. The switch instruction indicating to initiate the second data path may further be based on the second source node ID identifying the first PF as the second source node for initiating the second data path.

The packet header configuration information may further include a query indication. The query indication may indicate that a leaf node of the first data path should send a query message to the control plane function requesting for further instructions when the leaf node receives the packet including the packet header. The packet header may include the first indicator indicating a completion of the packet's last hop of the first data path. The packet header may further include the bitstring indicating the first PF as a leaf node of the first data path. The packet header may further include the second source node ID identifying the first PF as the second source node for initiating the second data path.

The method may further include sending, by the first PF to the control plane function, the query message, wherein the packet header configuration information is a response to the query message.

The method may further include encapsulating, by the first PF into the packet header, a second configured packet header information based on the first configured packet header information and the packet header configuration information. The method may further include sending, by the first PF to a third PF, the packet according to the second data path.

The method may further include receiving, by the first PF from the control plane function, configuration information for the second forwarding table. The configuration information may include one or more neighbor node for a next-hop. The configuration information may further include forwarding bit mask (FBM) information associated with each neighbor node indicating a set of leaf nodes that can be reached via said each neighbor node, the set of leaf nodes associated with the second data path.

The third PF may be a neighbor node indicated by the configuration information of the second forwarding table. The second configured packet header information may include a result of a bitwise AND (&) operation. The result of the bitwise AND (&) operation may be based on the second bitstring. The result of the bitwise AND (&) operation may further be based on an FBM information of the second forwarding table and associated with the neighbor node. The second configured packet header information may further include an updated indicator based on the second indicator. The second configured packet header information may further include the second source node ID. The second configured packet header information may exclude one or more of: the first indicator, the first bitstring, and the first source ID.

The packet header configuration information may further indicate a second set of functions to be performed by one or more PFs of a second set of PFs, and the method may further include processing, by the first PF, the data according to one or more functions of the second set of functions to obtain a second result.

The second configured packet header information may further indicate a third set of functions including the second set of functions and excluding the one or more functions used to obtain the second result.

The method may further include encapsulating, by the first PF into a payload of the packet, one or more of: the first result and the second result. Sending, by the first PF to the third PF, the packet according to the second data path may include sending the packet including the payload.

According to another aspect, another method is provided for transmitting an enhanced packet in executing a mission. The method may be performed by a PF of a plurality of PFs involved in a mission. The method includes sending, by a first processing function (PF) to a second PF, a packet according to a data path, the packet including a packet header, and the packet header including packet header information. The packet header information may include a set of functions to be performed by one or more PFs including the second PF. The packet header information may further include a forwarding table identifier (ID) identifying a forwarding table for the data path.

The packet header information may further include an indicator corresponding to the data path, the indicator indicating a number of hops remaining for the packet to perform to reach a destination of the data path. The packet header information may further include a source node ID identifying a source node for initiating the data path. The packet header information may further include a bitstring indicating one or more leaf node of the data path.

The packet header information may further include a query indication. The query indication may indicate that a leaf node of the data path should send a query message to a control plane function requesting for further instructions when the leaf node receives the packet including the packet header. The packet header may include the indicator indicating a completion of the packet's last hop of the data path. The packet header may further include a second source node ID identifying a second source node for initiating a second data path.

According to another aspect, an apparatus is provided. The apparatus includes modules configured to perform one or more of the methods and systems described herein.

According to one aspect, an apparatus is provided, where the apparatus includes: a memory, configured to store a program; a processor, configured to execute the program stored in the memory, and when the program stored in the memory is executed, the processor is configured to perform one or more of the methods and systems described herein.

According to another aspect, a computer readable medium is provided, where the computer readable medium stores program code executed by a device and the program code is used to perform one or more of the methods and systems described herein.

According to one aspect, a chip is provided, where the chip includes a processor and a data interface, and the processor reads, by using the data interface, an instruction stored in a memory, to perform one or more of the methods and systems described herein.

Other aspects of the disclosure provide for apparatus, and systems configured to implement the methods according to the first aspect disclosed herein. For example, wireless stations and access points can be configured with machine readable memory containing instructions, which when executed by the processors of these devices, configures the device to perform one or more of the methods and systems described herein.

Embodiments have been described above in conjunction with aspects of the present invention upon which they can be implemented. Those skilled in the art will appreciate that embodiments may be implemented in conjunction with the aspect with which they are described but may also be implemented with other embodiments of that aspect. When embodiments are mutually exclusive, or are incompatible with each other, it will be apparent to those skilled in the art. Some embodiments may be described in relation to one aspect, but may also be applicable to other aspects, as will be apparent to those of skill in the art.

### BRIEF DESCRIPTION OF THE DRAWINGS

Further features and advantages of the present invention will become apparent from the following detailed description, taken in combination with the appended drawings, in which:

FIG. 1A illustrates a mission comprising several tasks.

FIG. 1B illustrates the mission of FIG. 1A in terms of PFs.

FIG. 2 illustrates a packet header.

FIG. 3 illustrates a bit indexed explicit replication procedure.

FIG. 4 illustrates a format of BIERv6 packet.

FIG. 5 illustrates an applicable XaaS system architecture, according to an aspect.

FIG. 6 illustrates a connection between two border processing functions, according to an aspect.

FIG. 7 illustrates PFs involved in multiple missions, according to an aspect.

FIG. 8A and 8B illustrate paths of data forwarding and data processing of a mission, according to an aspect.

FIG. 9 illustrates an improved packet header, according to an aspect.

FIG. 10 illustrates a procedure for data forwarding and data processing, according to an aspect.

FIG. 11 illustrates another procedure for data forwarding and data processing, according to an aspect.

FIG. 12 illustrates a PF packet header, according to an aspect.

FIG. 13 illustrates another procedure for data forwarding and data processing, according to an aspect.

FIG. 14 illustrates an apparatus that may perform any or all of operations of the above methods and features explicitly or implicitly described herein, according to different aspects of the present disclosure.

FIG. 15 illustrates a method for data forwarding and data processing by a control plane function, according to an aspect.

FIG. 16 illustrates a method for data forwarding and data processing by a source node, according to an aspect.

FIG. 17 illustrates a procedure for data forwarding and data processing by an intermediate node, according to an aspect.

FIG. 18 illustrates a procedure for data forwarding and data processing by a leaf node, according to an aspect.

FIG. 19 illustrates a method for transmitting an enhanced packet in executing a mission, according to an aspect.

FIG. 20 illustrates another method for data forwarding and data processing by a control plane function, according to an aspect.

FIG. 21 illustrates another method for data forwarding and data processing by a source node, according to an aspect.

FIG. 22 illustrates another method for data forwarding and data processing by an intermediate node, according to an aspect.

FIG. 23 illustrates another method for data forwarding and data processing by a leaf node, according to an aspect.

FIG. 24 illustrates another method for transmitting an enhanced packet in executing a mission, according to an aspect.

It will be noted that throughout the appended drawings, like features are identified by like reference numerals.

### DETAILED DESCRIPTION OF THE ILLUSTRATIVE EMBODIMENTS

The disclosure provides for systems and methods for data forwarding and data processing.

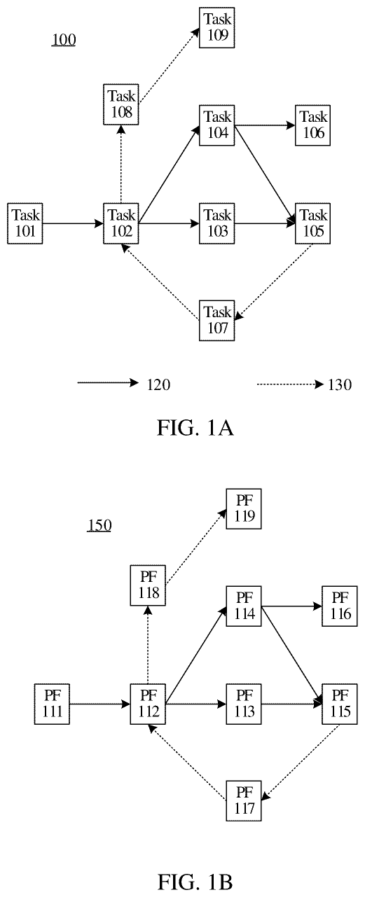

In sixth generation (6G) wireless communication system, X as a service (XaaS) network is proposed. The network works based on mission management concept. FIG. 1A illustrates a mission comprising several tasks. As illustrated, mission 100 may include several tasks (e.g., Tasks 101 to 109), and each task may be provided by a 6G service, e.g., data analytics and management (DAM) service, network for artificial intelligence (NET4AI) service, etc.

The tasks of mission 100 may be executed in specific order, and each task can be executed by a data processing function (PF) on the data plane as illustrated in FIG. 1B. FIG. 1B illustrates the mission of FIG. 1A in terms of PFs. The mission 150 corresponds to the mission 100 in terms of data PF or PF. Thus, tasks 101 may be executed or performed by data PF (or PF) 111, task 102 may be performed by PF 112, and similarly for each of remaining tasks, a corresponding PF may execute the task.

Data may be delivered to the PFs and the PFs may perform one or more data processing functions, e.g., data cleaning, AI training, AI inference, data analytics, data privacy protection, data storage, etc. Both data forwarding and data processing may be needed on data plane to execute a mission in 6G networks.

As mentioned, mission 100 may be executed in a specific order, for example, mission 100 may first be performed (e.g., data forwarded and tasks executed) according to the solid line arrows 120 and second according to the dotted line arrows 130. Thus, mission 100 may be performed according to a data forwarding sequence. Mission 100 may first, forward data according to a first data path based on the solid line arrows 120, and second, forward data according to a second data path based on the dotted line arrows 130.

The characteristics of traffic topology of the mission 100 may be described as follows. The traffic path of the mission may be a directed graph. The traffic path may include path forks e.g., packets from PF 112 is transmitted to both PF 113 and PF 114. That is, multicast transmission may be needed. In some aspects, the path may have transmission loop(s) and is not loop-free, which is different from data forwarding in traditional network. In traditional network, data forwarding is done to avoid transmission loops. However, in future 6G service, transmission loops may exist to perform data processing. For example, data forwarded from PF 112 to PF 113 and further to PF 115 (based on data path associated with the solid line arrows) may then be forward back to PF 112 from PF 117 and PF 115 (based on a data path associated with the dotted line arrows). At the same time, PF 115 may receive data from both path segments PF 112-PF 114-PF 115 and PF112-PF113-PF115. The traffic path may have aggregation points, e.g., at PF 115.

One technology for performing multicast transmission may be Bit Indexed Explicit Replication (BIER). The BIER technique may be used for multicast transmission and can be leverage to reduce the status maintained in the network node (e.g., router). BIER can be also utilized for unicast transmission. BIER uses BitString as the match files and does not depend on Multicast Distribution Tree (MDT).

Each edge network node (e.g., edge routers, leaf nodes) in BIER is identified by a determined bit position called the Bit-Forwarding Router ID (BFR-ID). For example, the BitString 1001 identifies 2 edge network nodes, namely the node with the identifier 1000 and the node with 0001. Thus, one BitString can identify multiple nodes, which can guide the intermediate network node to replicates the packets explicitly.

The network node may be a router, as an example. The BIER-supported router is called the Bit-Forwarding Router (BFR). The ingress router of the BIER domain is called the Bit-Forwarding Ingress Router (BFIR) while the egress router is the Bit-Forwarding Egress Routers (BFERs). In the BIER domain, all the BFRs maintain the Bit Index Forwarding Tables (BIFT) towards all the possible BFERs (also the edge routers). Thus, in BIER, the table status in the routers is related to the network topology. To eliminate the multicast storm and the loop, the BFR modifies the BitString after each matching process to prevent the redundant replication.

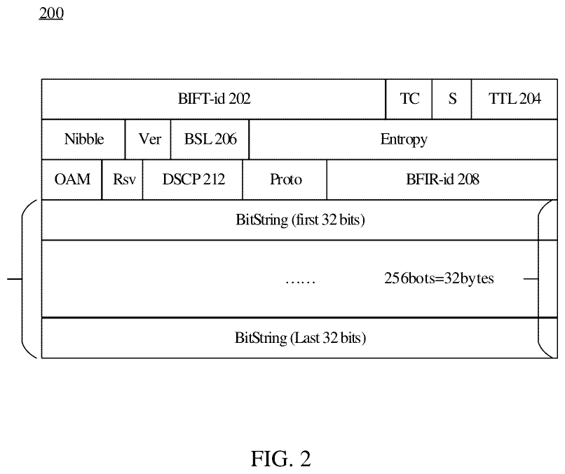

FIG. 2 illustrates a packet header. The packet header 200 may be similar to a BIER packet header. The packet header 200 may include a plurality of fields indicating: bit Index Forwarding Table identifier (BIFT-id), traffic class (TC), S bit of label stack (S), time to live (TTL), Nibble, version number (Ver), BitString length (BSL), Entropy for load balancing purposes, operations administration and management (OAM), reserved bit (Rsv), Differentiated Services Code Point (DSCP), next protocol (Proto), BFIR-id, and BitString, as illustrated.

BIFT-id field 202 identifies a Bit Index Forwarding Table, and the BIFT-id field 202 can include 4 bit BSL+8 bit Sub-Domain+8 bit Set ID. The BSL field 206 indicates the BitString length, which its value can be 64, 128, 256, 512, 1024, etc. For example, value 0001 indicates that the BSL length is 64 bits, value 0010 indicates that the BSL length is 128 bits, and value 0011 indicates that the BSL length is 256, etc.

The default value for BFIR-id 208 is the BFR-id (e.g., BFR-id of source node, BFR-id of next-hop node), the value of which can be 1-65535. BitString field 210 indicates the set of destination nodes of packets, e.g., multicast packets. BitString can be a Bit Mask.

The TTL field 204 indicates the remaining number of hops the packet is to take or to be forwarded to reach the destination (e.g., a leaf node). The TTL value decreases by 1 each time the packet passes through a forwarding node. In some aspects, when the TTL value is 0, the packet is discarded. In some aspects, if a packet's TTL is 1 or greater and one of the bits in its BitString identifies the current node, then the current node may process the packet, e.g., by removing the encapsulation and/or processing the payload. The DSCP field 212 can be used for differentiated service, e.g., with QoS classification.

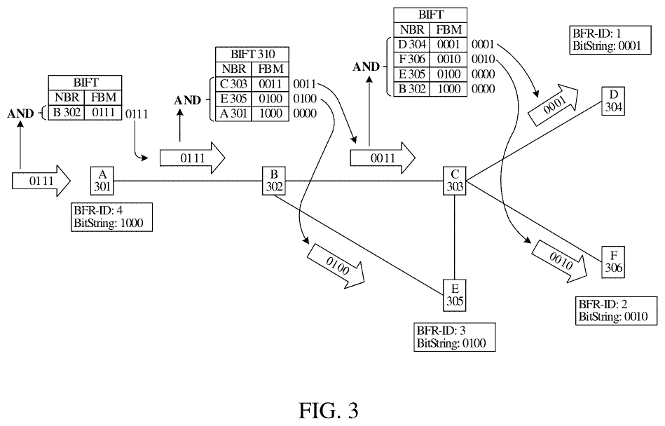

In BIER, packet is forwarded at each node based on the BitString and the BIFT as illustrated in FIG. 3. FIG. 3 illustrates a bit indexed explicit replication procedure. Each node is configured with a BIFT which includes one or more neighbor (NBR) nodes and corresponding forwarding bit mask (FBM) information for each NBR node.

NBR indicates the next-hop neighbor of the node. FBM indicates the set of egress nodes (leaf nodes) in the BIER domain that can be reached through the next-hop neighbor when packets are replicated and sent to the next-hop neighbor.

For example, for the FBM of the BIFT 310 at node B 302, the FBM corresponding to NBR C 303 has value, 0011, which indicates that neighbor C 303 of node B 302 can reach to the leaf nodes corresponding to the position bit=1, e.g., D and F. The FBM is also a BitString, whose length is the same as that of the BitString in the packet header.

The ingress node and the egress nodes are assigned Bitstring. For example, the BitString assigned to node D 304, F 306, E 305, A 301 are respectively 0001, 0010, 0100, and 1000. If the nodes D 304, E 305, and F 306 are the receivers of the multicast transmission, the source node A 301 sets the bit positions corresponding to them to 1, e.g., the BitString 0111.

Each node performs the bitwise AND (&) operation between the BitString in the packet header and the FBM of each neighbor in the BIFT. If the result of the bitwise AND (&) operation is not 0, the current node encapsulates the bitwise AND result into the “BitString” field 210 of the packet header and sends the packet to the corresponding neighbor. Encapsulating the bitwise AND result into the packet header prevents duplication. If the BitString is not reset, loop transmission will happen. For example, the operation at node B 302 is to reset the BitString towards C 303 to 0111&0011=0011, and reset the BitString towards E 305 to 0111&0100=0100.

The BIFT should be also calculated (e.g., by control plane) to prevent path loop. In some cases, a neighbor node's FBM in the BIFT of a node depends on the neighbor node's connected leaf nodes in the stream direction (downstream or upstream). But not always, for example, referring to BIFT 310 of node B 302, the FMB of node C 303, is 0011 instead of 0111 because node E 305 connects to both node C 303 and node B 302, and node B 302 is the root of both node C 303 and node E 305. If there is link between node B 302 and node E 305, then there is no need for node C 303 to transmit duplication packet to node E 305. However, this may change in the future 6G where packet duplication and path looping may be necessary for data forwarding and data processing to be performed at one or more network nodes.

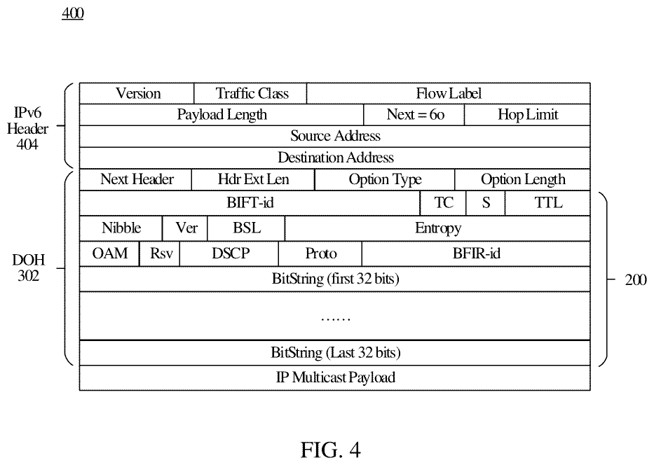

BIERv6, illustrated in FIG. 4, is a technology that leverages the BIER and IPV6. FIG. 4 illustrates a format of a BIERv6 packet. BIERv6 400 uses an IPV6 Destination Options Header (DOH) 402 to carry a standard BIER header 200. In addition, the DOH 302 includes further fields indicating: next header, Header Extension Length, option type and option length.

The DOH header 302 and the IPV6 header 404 form a BIERv6 header 400. The IPV6 header 404 includes a plurality of fields indicating: version, traffic class, flow label, Payload length, Next=60, hop limit, source address and destination address as illustrated. A network node reads the BitString in the BIERv6 header, updates the BitString and forwards the packet based on the BIFT identified by the BIFT-id.

In BIER, packets have embedded segment list for traffic steering. The underlay tunnel can be shared by multiple data flows, which may be viewed as consistent with the requirement of the 6G network for mission management. However, BIER technology has limitations or shortcomings which may render the technology inadequate for 6G networks, as BIER can achieve no per-flow or per-tunnel state inside network.

One of the targets of BIER technology for data forwarding is to ensure that no loop occurs in packet forwarding path. The data forwarding will stop at the leaf nodes. However, in future 6G networks and provision of XaaS, ability to loop data may be needed to perform data processing, e.g., in reference to FIG. 1B, from PF 112 to PF 113 to PF 115 and then back to PF 112 (via PF 117). In some cases, packets (e.g., raw packets, processed packets) may be required to be transferred back and forth between two nodes several times. Thus, ability to loop data is desirable for accommodating data paths in future networks.

While BIER obviates the need for MDT, the technology prevents loop path, which, as mentioned, may be needed in 6G networks. Further, BIER and other existing technologies related to data forwarding prevent a node from receiving packets from different upstream nodes (i.e., from different path segment) to ensure that no duplicated packet is transmitted to the same node.

For example, referring to FIG. 1B, the path associated with the solid line arrows has aggregation point, e.g., at PF 115. Referring to FIG. 3, the one or more BIFTs of BIER prevent the path segment from node B 302 to node E 305 and the path segment from node B 302 to node C 303 and to node E 305 to coexist at the same time. Some path segments cannot be simultaneously covered within one BIFT under BEIR. However, future 6G service may require, for example, node B 302 to send packets to node C 303, while at the same time, requiring, node E 305 to send the processed result of packets from node B 302 to node C 303. Thus, the two path segments (first path segment: from node B 302 to node C 303, and second path segment: from node B 302 to node E 305 to node C 3030) should be activated in the data plane for provision of 6G service. Accordingly, existing technologies should be improved to allow for data loop paths and packet duplications to accommodate 6G services.

In 6G network, both data forwarding and data processing should be natively enabled. The data processing configuration may be carried in packet header. The data processing configuration included in the packet header for a node must be correctly or appropriately mapped to that node. However, BIER technology has limited or weak scalability in terms of data processing configuration. Thus, correctly mapping the data processing configuration for specifics nodes (e.g., intermediate nodes) in multicast packets is a challenge. For example, some intermediate nodes connected to an aggregation node, or intermediate nodes in a unicast path may have same BIFT and FBM, and no BFR-ID assigned to them. Determining how to map data processing configuration for these intermediate nodes is yet to be determined.

Some aspects of the disclosure may enable loop transmission in a mission. According to an aspect, traffic may be enabled to go through the correct traffic path, especially when the path has forks and aggregations in 6G mission.

According to some aspects, data processing configuration and data forwarding configuration for a same node may be appropriately or correctly bound, and may be available and efficient for various cases (e.g., unicast, multicast, loop-free, or non-loop-free).

In some aspects, a packet header can be a protocol layer header, for example, a PF protocol layer header, and the protocol layer may be deployed at one of: on top of the Packet Data Convergence Protocol (PDCP) sublayer, between the Service Data Adaptation Protocol (SDAP) sublayer and the PDCP sublayer, between the PDCP sublayer and the Radio Link Control (RLC) sublayer, between the RLC sublayer and the Media Access Control (MAC) sublayer, between the MAC sublayer and physical layer (PHY), on top of the SDAP sublayer, on top of a protocol data unit (PDU) layer, on top of a GTP-U layer, on top of UDP layer, on top of an IP layer, on top of a QUIC layer, on top of a Hypertext Transfer Protocol (HTTP) layer, on top of a segment routing over IPv6 (SRv6) layer, within the PDU layer, within the SDAP sublayer, within the PDCP sublayer, within the RLC sublayer, within the MAC sublayer, within the PHY layer, within the GTP-U layer, within the UDP layer, within the IP layer, within the application layer, within HTTP layer, within SRv6 layer, and within the QUIC layer.

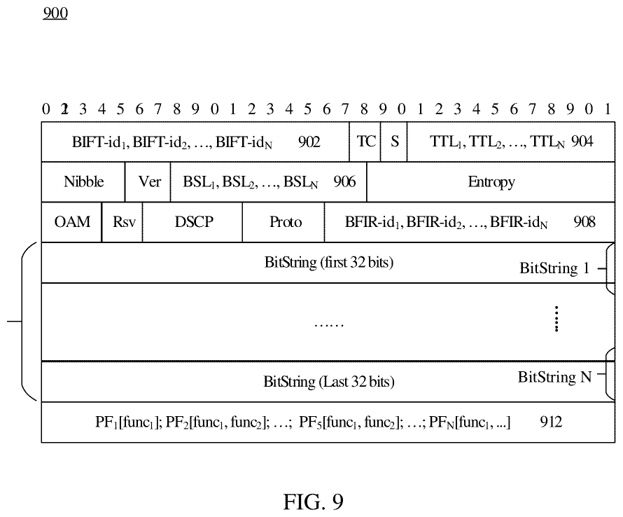

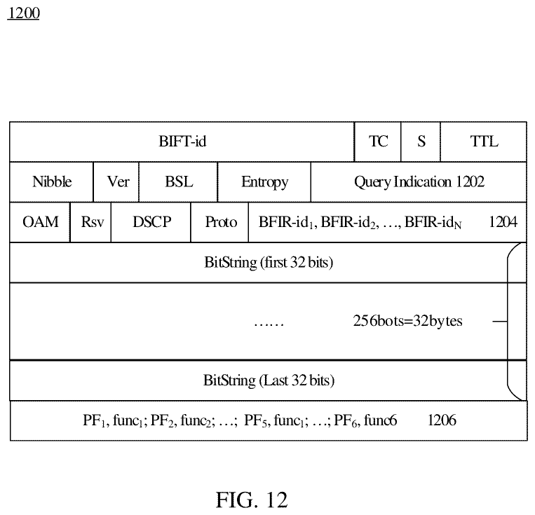

According to some aspects, improved packet headers (e.g., in reference to FIG. 9 and FIG. 12 may be provided to support the per-flow or per-tunnel traffic steering in loop transmission among different network node.

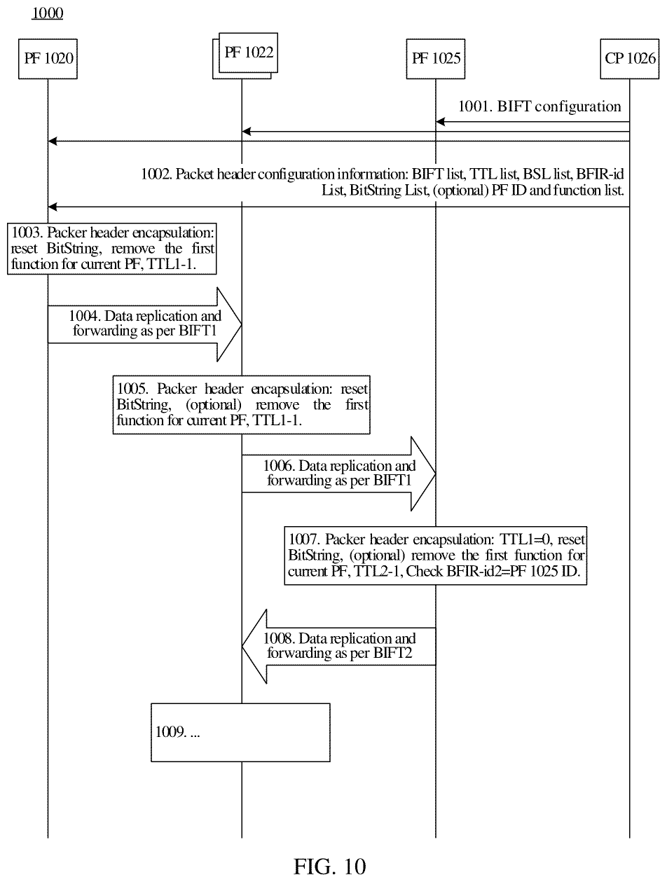

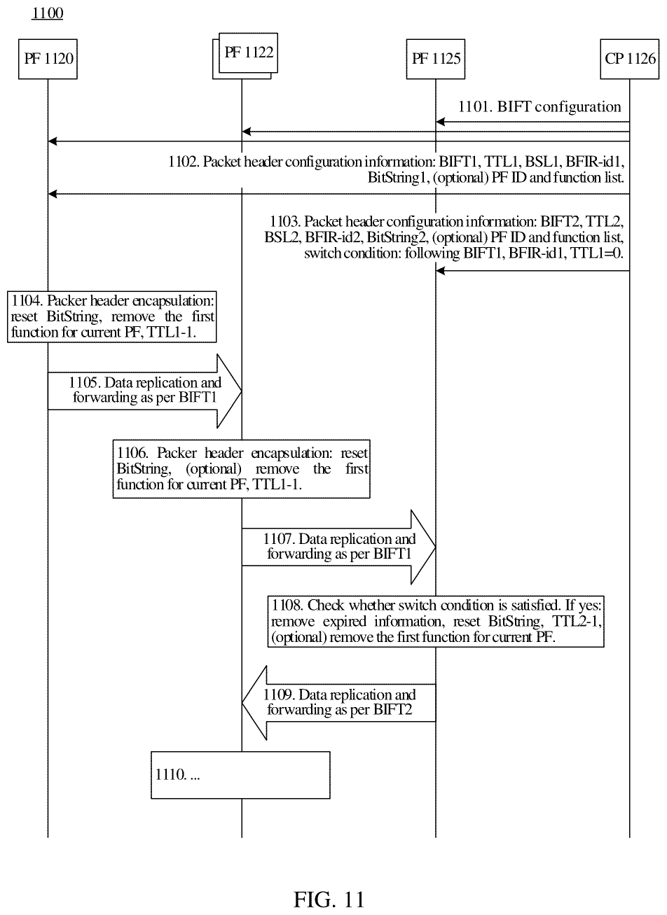

In some aspects, the improved packet header may be an in improvement to the BIER packet header. As described in reference to FIG. 10, the improved packet header may be leveraged into a packet header of new protocol layers (e.g., PF protocol layer). The information to be included into a PF packet header is specified and described herein, e.g., in reference to FIG. 10 and FIG. 11.

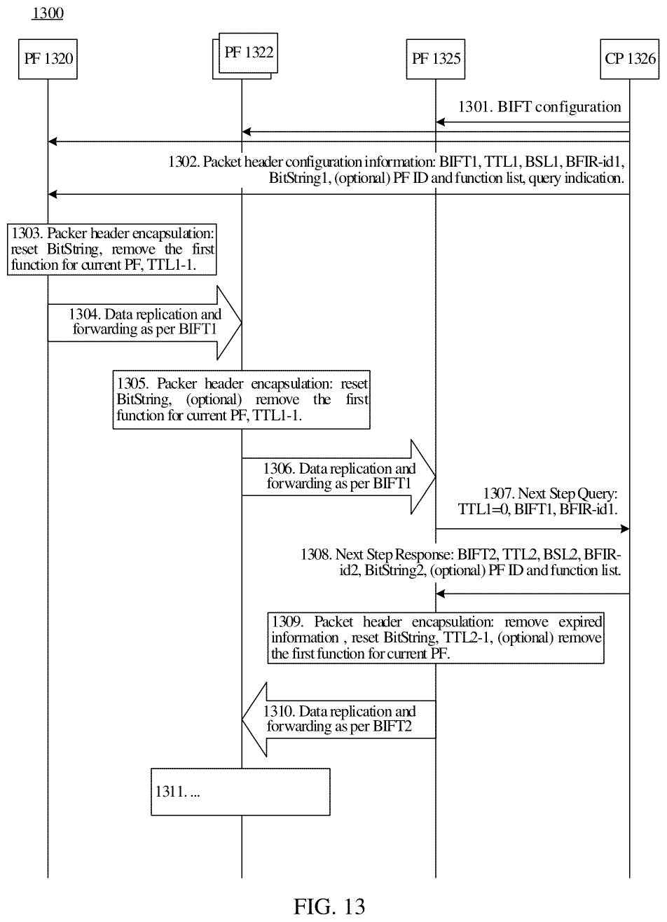

According to some aspects, the control plane may instruct one or more nodes (e.g., a node in a loop, an intermediate node) to perform correct or appropriate actions. In some aspects, another packet header (e.g., in reference to FIG. 12) may be provided that may leverage information in the BIER packet header into the packet header of new protocol layers (e.g., PF protocol layer). In some aspects, the information in the BIER packet header can be modified and leveraged into a packet header of new protocol layers (e.g., PF protocol layer), as described, for example, in reference to FIG. 12 and FIG. 13.

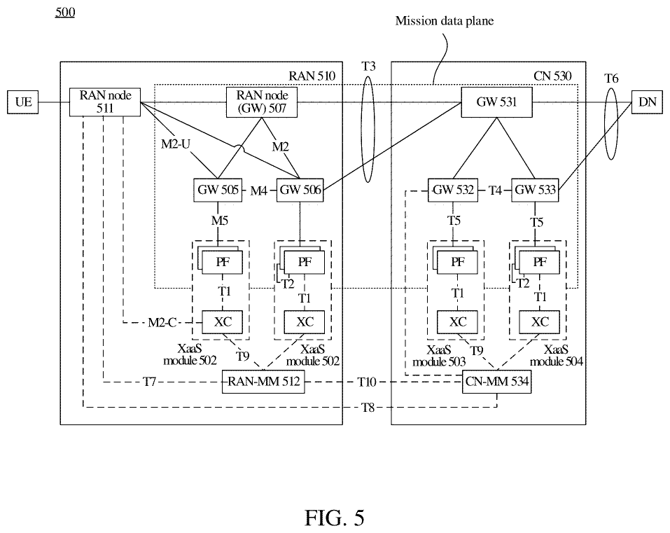

FIG. 5 illustrates an applicable XaaS system architecture, according to an aspect. The system architecture 500 illustrates an example architecture to which one or more aspects of the disclosure may be applicable.

In an aspect, XaaS modules 501 and 502 are deployed at RAN side 510 and XaaS modules 503 and 504 are deployed at CN side 530. The Mission management functions (MMs) may be deployed according to a hierarchy (e.g., MM hierarchy). The MMs are to control, manage and configure the network to perform a mission, e.g., the MMs control, manage and configure the network functions (e.g., gateway, XaaS module) to establish the resources for executing one or more tasks involved in a mission. MMs may be named with other terminologies, e.g., mission control function (MCF). In some aspects, system architecture 500 may comprise one or more of global MM and domain MM. In some aspects, the hierarchy may be due to mission hierarchy (e.g., mission under the control of global MM, and submission under the control of domain MM), or due to network administration hierarchy (e.g., RAN and CN). A domain may refer to an administrative domain or a mission management domain. For example, there are MMs deployed in RAN and CN respectively, i.e., RAN-MM and CN-MM. The global MM and the domain MM can be located in the same network domain or different network domains. For example, both the two MMs (the global and domain MMs) may be located in CN 530, i.e., CN-MMs, or in RAN 510, i.e., RAN-MMs, or one may be located in RAN while the other located in CN.

Each XaaS module may comprise XaaS service controller (XC) and one or more PFs. An XC may connect with PF via T1 interface. Some PFs of an XaaS module may be border PFs (e.g., ingress PFs, egress PFs) to connect to external entities.

One or more gateways (GWs) on data plane may be deployed in RAN and CN. In an aspect, a RAN-GW (e.g., GW 505) may connect to a RAN-PF via an M5 interface. In some aspects, a RAN-GW (e.g., GW 505) may connect to another RAN-GW (e.g., GW 506) via an M4 interface. In some aspects, a RAN-GW (e.g., GW 505) may connect to a RAN node 507 via an M2 interface. In some aspects, a RAN-GW (e.g., GW 506) may connect to a CN-GW (e.g., GW 531) via a T3 interface.

In some aspects, a CN-GW (e.g., GW 532) may connect to a CN-PF via a T5 interface. In some aspects, a CN-GW (e.g., GW 532) may connect to another CN-GW (e.g., GW 533) via a T4 interface. In some aspects, a CN-GW (e.g., GW 533 and 533) may connect to a data network (DN) via a T6 interface.

In some aspects, integrated or split RAN node(s) may be deployed at the system architecture 500.

If integrated RAN node is deployed (e.g., central unit (CU) or distributed unit (DU) are not deployed), a RAN node (e.g., RAN node 511) may connect to XC via an M2-C interface. In some aspects, RAN node 511 may connect to a GW (e.g., GW 505) via an M2-U interface. In some aspects, RAN node 511 may connect to a PF via M2-U and M5 interfaces. In some aspects, RAN node 511 may connect to RAN-MM 512 via a Ty interface. In some aspects, RAN node 511 may connect to CN-MM 534 via T8 interface. In some aspects, a RAN node (e.g., RAN node 507) may connect to CN-GW 531 via a T3 interface. In some aspects, RAN node 511 may connect to a user equipment (UE) a via radio link.

If split RAN node is deployed (e.g., CU and DU are deployed), in some aspects, a first split part (e.g., DU) of RAN node 511 may connect to XC via an M2-C interface. In some aspects, the DU of RAN node 511 may connect to GW 505 via M2-U interface. In some aspects, the DU of RAN node 511 may connect to PF via M2-U and M5 interfaces. In some aspects, the DU of RAN node 511 may connect to UE via radio link. In some aspects, a second split part (e.g., CU) of RAN node 511 may connect to XC via an M2-C interface. In some aspects, the CU of RAN node 511 may connect to GW 505 via an M2-U interface. In some aspects, the CU of RAN node 511 may connect to PF via M2-U and M5 interfaces. In some aspects, the CU of RAN node 511 may connect to RAN-MM 512 via a T7 interface. In some aspects, the CU of RAN node 511 may connect to CN-MM 534 via a T8 interface. In some aspects, the CU of RAN node 507 may connect to CN-GW 531 via a T3 interface. In some aspects, RAN node 511 is a DU of a RAN base station, and RAN node 507 is a CU of a RAN base station. In some aspects, RAN node 511 is a DU of a RAN base station. In some aspects, RAN node 507 is a CU of a RAN base station.

In some aspects, a RAN-GW can connect to CN-GW directly (e.g., GW 506) via a T3 interface, or intermediately (e.g., GW 505) via a RAN node (e.g., RAN node 507).

In some aspects, GWs are optionally deployed. In some aspects, when GWs are not deployed at RAN, the RAN node can connect to a CN-GW directly via a T3 interface.

In some aspects, the PFs (i.e., border PFs and intermediate PFs) within a XaaS module intra-connect via a T2 interface, and PFs (i.e., border PFs) deployed in different XaaS modules inter-connect via GW(s) or directly. For example, on CN side 530, PFs deployed in different XaaS modules can connect with each other via GW(s). On RAN side 510, PFs deployed in different XaaS modules can connect with each other via T2 interface directly. In some aspects, RAN-PFs deployed in different XaaS module can connect with each other via GW(s).

In some aspects, a RAN-PF can connect to CN-GW via the intermediate M5 and T3 interfaces. In some aspects, a RAN-PF can connect to a CN-GW via the intermediate M5, M2 and T3 interfaces. If the GWs are not deployed in RAN, the RAN-PF can connect to CN-GW directly, or via an intermediate RAN node.

In some aspects, an MM (e.g., RAN MM 512 and CN MM 534) may connect to an XC via a T9 interface. In some aspects, hierarchical MMs may connect with each other via T10 interface directly or via one or more intermediate entities. For example, Hierarchical MMs in the same domain (e.g., both in CN) can connect with each other via the T10 interface directly which can be a SBI interface. In some aspects, hierarchical MMs in the same domain (e.g., both in RAN) can connect with each other via a RAN node. In some aspects, hierarchical MMs in the same domain (e.g., both in CN) can connect with each other via a connectivity management function (CM). The CM may provide a capability of connectivity management by maintaining connectivity between end-points (e.g., devices, mobiles, terminals) of end customers and the 6G system, e.g., to maintain the reachability and connectivity of end-points for mobility tracking, status update, 6G radio bearer establishment. In some aspects, hierarchical MMs in different domains (e.g., RAN-MM and CN-MM) can connect with each other via a RAN node (i.e., via the intermediate T8 and T7 interfaces), or directly via a T10 interface.

In some aspects, one or more entities illustrated in FIG. 5 can integrated as one entity, e.g., RAN node and XaaS modules on RAN side can be integrated.

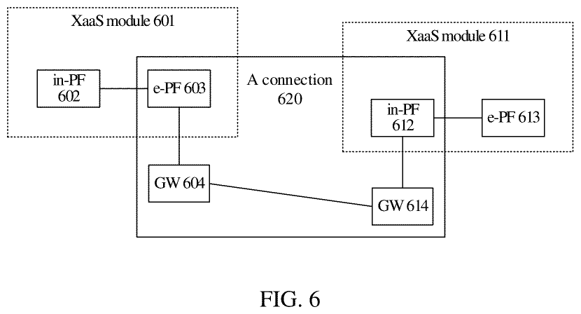

FIG. 6 illustrates a connection between two border processing functions, according to an aspect. XaaS module 601 may comprise two border PFs, ingress PF 602 and egress PF 603. Similarly, XaaS module 611 may comprise two border PFs, ingress PF 612 and egress PF 613. In some aspects, an ingress PF and an egress PF may be the same PF.

An egress PF 603 of an XaaS module 601 may connect to an ingress PF 612 of another XaaS module 611 directly or via intermediate entity (e.g., GW 604 and 614). The link between the egress PF 603 of a XaaS module 601 and the ingress PF 612 of another XaaS module 611 may be referred to as a connection 620. Connection 620 may include one or more GWs (e.g., GW 604 and 614). In some aspects, connection 620 may not involve GW e.g., when connection 620 is direct between the border PFs).

In some aspects, connection 620 can be the overlay and on top of transport layer, e.g., on top of: Quick UDP Internet Connection (QUIC) connection, General Packet Radio Service (GPRS) Tunneling Protocol-User Plane (GTP-U) tunnels, User Datagram Protocol (UDP) connection, and Internet Protocol (IP) connection. The transport layer is on the top of network layer (e.g., on the top of IP layer).

In an aspect, a new PF protocol layer may be deployed in the system, for example, a PF protocol layer may be deployed on top of TNL, e.g., on top of: GTP-U, UDP, QUIC, IP, or Segment Routing over IPv6 (SRv6) protocol layer. The PF protocol layer can be deployed in the PF unit of an XaaS module, or deployed in RAN, in UE, etc. The connection 620 between the two PFs can be established between two PF entities of a PF protocol layer which can be on top of: QUIC, GTP-U, UDP, IP, or SRv6 protocol layer. The mapping between the connection 620 and GTP-U tunnels, UDP connection, IP connection, QUIC connection, and SRv6 connection can be configured. In some aspects, a connection 620 can be identified by a Connection ID.

In some aspects, a connection 620 can be established between two CN-PFs. In some aspects, a connection 620 can be established between. In some aspects, a connection 620 can be established between two RAN-PFs. In some aspects, a connection 620 can be established between a RAN node (e.g., a RAN base station, a RAN-PF) and a CN-PF. In some aspects, one or multiple GWs can be the intermediate entities between the two PFs as part of connection 620.

In some aspects, connection 620 can be established by configuring PF protocol layer parameter and corresponding TNL (Transport Network Layer) parameter to one or more of PFs, GWs and RAN nodes.

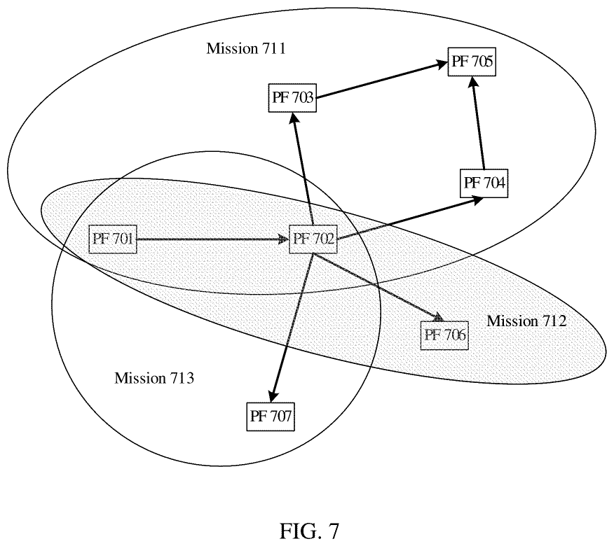

FIG. 7 illustrates PFs involved in multiple missions, according to an aspect. The path between two or more entities (e.g., PF 701 and PF 702) may be the overlapped segment of different missions or submissions. For example, the path between PF 701 and PF 702 is an overlapped segment of a first submission (executed by PF 701, PF 702, and PF 703) and a second submission (executed by PF 701, PF 702 and PF 704) of a same mission 711 (executed by PF 701, PF 702, PF 703, PF 704, and PF 705). The path between PF 701 and PF 702 is also an overlapped segment among mission 711, mission 712 (executed by PF 701, PF 702 and PF 706) and mission 713 (executed by PF 701, PF 702 and PF 707).

A connection on the data plane between two PFs may be established per one or more of: mission, submission, and per UE, under the control of control plane. In existing technologies, for each mission participation (e.g., a UE), the control plane may configure the PFs along the path to establish 4 dedicated connections (e.g., 4 data plane tunnels) between PF 701 and PF 702 for submission 1 of mission 711, submission 2 of mission 711, mission 712 and mission 713, respectively. If multiple UEs participate, the number of connections on the data plane will multiply. As a result, configuration complexity and delay, under the existing technologies, may increase due to, for example, the increased required number of operations (e.g., the control plane sending messages to each of the PFs along the path and configuring them to establish the connections needed to execute the missions).

According to some aspects, an improved packet header may be provided that may be used among PF entities at the PF protocol layer for per-flow, per-tunnel traffic steering in loop transmissions. In some aspects, the improved packet header may be an improvement to the BIER packet header as described herein.

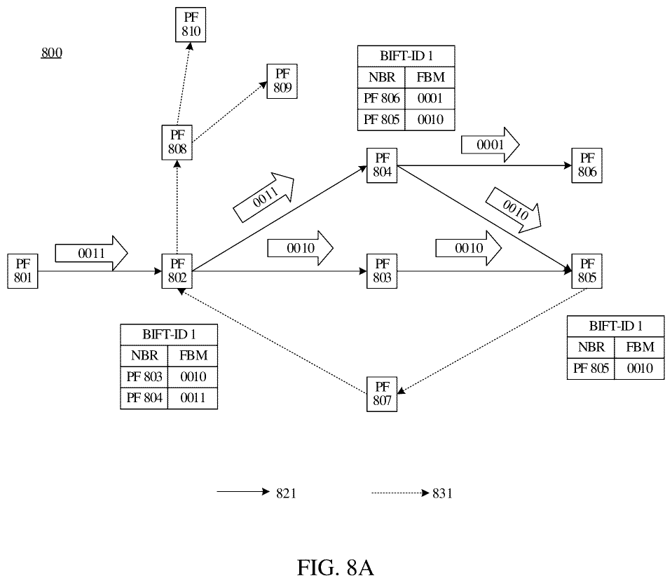

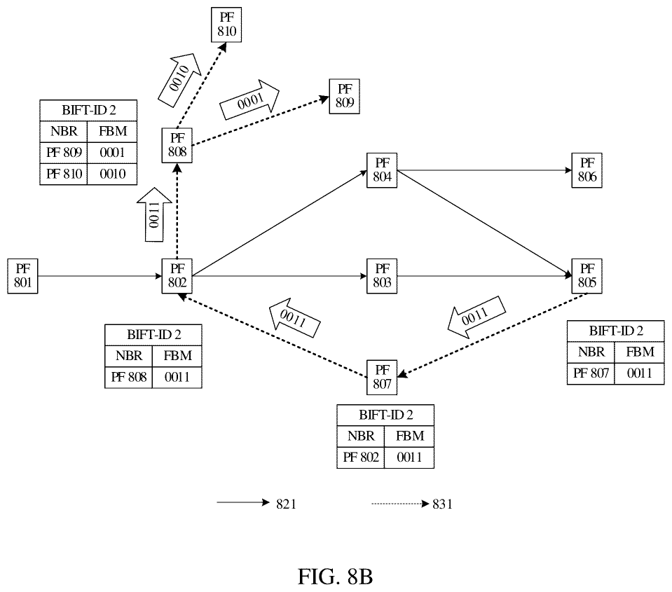

FIG. 8A and 8B illustrate paths of data forwarding and data processing of a mission, according to an aspect. A mission 800 may comprise a plurality of paths for data forwarding and data processing (e.g., a first path (or data path) 821 indicated by solid line arrows (or solid line) 821 and a second path 831 indicated by dotted line arrows (or dotted line) 831). The mission may be performed according to a sequence, e.g., a data forwarding sequence. For example, the mission 800 may be performed first according to the first path indicated by solid line 821. The mission may then be performed according to the second path indicated by dotted line 831.

In the first path of mission 800, data may be forwarded and processed by PF 801, PF 802, PF 803, PF 804, PF 805, and PF 806. The first path may be initiated by or may have as its source node PF 801. The first path may have leaf nodes or destination nodes as PF 805 and PF 806 as illustrated.

In the second path of mission 800, data may be forwarded and processed by PF 805, PF 807, PF 802, PF 808, PF 809, and PF 810. The second path may be initiated by or may have as its source node PF 805. The first path may have leaf nodes or may have as its destination nodes PF 810 and PF 809 as illustrated. As indicated, the PF 805 may be a leaf of a first path 821 and a source node of the second path 831.

FIG. 9 illustrates an improved packet header, according to an aspect. The packet header 900 may be an improvement to the BIER packet header. In some aspects, packet header 900 may be a PF packet header. In some aspects, the packet header 900 can be applied in any suitable protocol layer, e.g., IP protocol layer, protocol layer on top of transport layer or network layer, the proposed PF protocol layer.

In some aspects, packet header 900 may be leveraged it into the PF protocol layer. The packet header 900 may include a plurality of fields indicating one or more of: BIFT id 902, TC, S, TTL 904, Nibble, Ver, BSL 906, Entropy, OAM, Rsv, DSP, Proto, BFIR-id 908, Bitstring 910, and functions 912.

In an aspect, the BIFT-id field 902 may indicate a BIFT-id list. The BIFT-id field 902 may include more than one BIFT-id. The BIFT-ids may be arranged in an order or sequence, e.g., data forwarding sequence. The order may indicate that a packet should be forwarded in sequence based on the BIFTs identified by the BIFT-ids. For example, the BIFT-ids may indicate that a packet should be forwarded firstly based on the BIFT-id₁, which may involve several hops (a number of hops can be indicated by the TTL field 904), then the packet should be forwarded based the BIFT-id₂, and so forth.

In an aspect, the TTL field 904 may indicate a TTL list. The TTL field 904 may include more than one TTLs. In an aspect, the TTLs may be arranged in the same order as BIFT-ids, thus the TTLs may correspond to the BIFT-ids. Each TTL may correspond to one BIFT-id. Each TTL may indicate the remaining number of hops a packet to be forwarded based on the corresponding BIFT. In some aspects, the TTL may indicate the number of hops for a packet to be forward to reach a destination or a leaf of a path according to the BIFT identified by the BIFT-id. The TTL value decreases by 1 each time the packet passes through a forwarding node (e.g., a hop). In some aspects, when the TTL value is 0, the packet may then be forwarded based on the next BIFT identified by the next BIFT-id, according to the order (e.g., data forwarding sequence), and the next TTL corresponding to the next BIFT-id may be used to count.

In an aspect, the BitString filed 910 may indicate a Bitstring list. The BitString filed 910 may includes more than one BitString. Each BitString may indicate a set of destination nodes (or leaf nodes) of packets. In some aspects, the BitSring may be a Bit Mask. In some aspects, the BitStrings may be arranged in the same order as BIFT-ids, thus, the BitSrings may correspond to the BIFT-ids. Each BitString may correspond to one BIFT-id. Accordingly, packets may be forwarded based on BIFT and BitString, according to the data forwarding sequence.

In an aspect, the BSL field 906 may indicate a BSL list. The BSL field 906 may include more than one BSL. BSLs may be arranged in the same order as BitString, thus the BSLs may correspond to the BIFT-ids. Each BSL may correspond to one BitString. Each BSL may indicate the length of the corresponding BitString. The value of BSL can be 64, 128, 256, 512, 1024, etc. For example, the value 0001 may indicate that the BSL length is 64 bits, the value ‘0010]’ may indicate that the BSL length is 128 bits, and the value 0011 may indicate that the BSL length is 256, etc.

In some aspects, the BFIR-id field 908 may indicate a BFIR-id list. The BFIR-id field may include more than one BFIR-ids. Each of the BFIR-ids may identify a source node (e.g., source PF) starting or initiating to perform data forwarding based on a new BIFT. Thus, each BFIR-id may indicate the source node for initiating a path (e.g., a data path) corresponding to the BIFT-id. In some aspect, the number of BFIR-ids in the packet header may be equal to the number of the BIFT-ids. BFIR-ids may be arranged in the same order as the BIFT-ids, and indicate a same data forwarding sequence.

In some aspect, the number of BFIR-ids in the packet header is not equal to that of the BIFT-ids. For example, the number of BFIR-ids is larger than that of the BIFT-ids. In these cases, there are more than one BFIR-ids corresponding to one same BIFT-id. The more than one BFIR-ids may identify more than one leaf nodes of a previous path, and the more than one leaf nodes will activate as new source nodes in the next path. Where more than one leaf node exists and when those node can each activate as a new source node for the next path, all the source nodes may start, e.g., in parallel, the next path. For example, the [BFIR-id1; (BFIR-id2, BFIR-id3); BFIR-id4; BFIR-id5] corresponds to [BIFT-id1; BIFT-id2; BIFT-id3; BIFT-id4], respectively. That is, a ‘BFIR-idx’ of the entry or a ‘(BFIR-idx, BFIR-idy, . . . )’ of the entry corresponds to a ‘BIFT-id’. As may be appreciated by a person skilled in the art, the mapping between the BFIR-ids and the BIFTs may be indicated according to any reasonable format.

As may be appreciated by a person skilled in the art, similar to BFIR-ids, the number of BSLs may be equal to or different from that of the BIFT-ids, and the mapping between BSLs and BIFT-ids may be indicated according to any reasonable format. As may be appreciated by a person skilled in the art, similar to BFIR-ids, the number of TTLs may be equal to or different from that of the BIFT-ids, and the mapping between TTLs and BIFT-ids may be indicated according to any reasonable format. As may be appreciated by a person skilled in the art, similar to BFIR-ids, the number of BitStrings may be equal to or different from that of the BIFT-ids, and the mapping between BitStrings and BIFT-ids may be indicated according to any reasonable format.

In some aspects, the BFIR-ids of the BIFR-id list, except the first BFIR-id, may identify the nodes which should switch from a leaf node to a source node. If a node receives a packet including a TTL of a specific value (e.g., TTL=0, TTL=1) and a BFIR-id identifying the node, then the node acknowledges that it is a source node starting to perform data forwarding based on a new BIFT identified by the next BIFT-id. Accordingly, the node may encapsulate the next BIFT-id and the next corresponding TTL into the packet header to be forwarded to next hop. For example, in FIG. 8A, the BFIR-id associated with BIFT identified by BIFT-id 1 (being the first BIFT-id according to the data forwarding sequence of mission 800) may indicate PF 801 as the source node to start performing data forwarding along the path indicated by solid line arrows 821). Similarly, in FIG. 8B, the next BFIR-id (being associated with BIFT identified by BIFT-id 2 (being the next BIFT-id after BIFT-id 1 according to the data forwarding sequence of mission 800) may indicate PF 805 as the source node for performing data forwarding along the path indicated by dotted line arrows 831.

In some aspects, the packet header 900 may indicate a node ID (via the BFIR-id field 908) identifying the next-hop node. A node receiving a packet indicating the node ID may encapsulate the BFIR-id identifying the next-hop node into the packet header, and the next-hop node may verify whether it is the right receiver based on the BFIR-id.

In some aspects, when a TTL of a specific value (e.g., TTL=0, TTL=1), the TTL and the corresponding BIFT-id, BLS, BFIR-id and BitString can be removed out of the packet header. For example, when a node (e.g., a PF) receives a packet including a packet header indicating a TTL with a specific value (e.g., TTL=0, TTL=1), the node may remove from the packet header one or more of: the TTL, the corresponding BIFT-id, corresponding BSL, corresponding BFIR-id and BitString.

In some aspects, the function field 912 may indicate one or more functions in a form of a function list. In some aspects, the one or more functions indicated via the function field 912 may be used for Data Processing Configuration, indicating the approach (e.g., the function) that a corresponding node needs to take for data processing. In some aspects, the corresponding node can be identified by a node ID, e.g., a BFIR-id, a PF ID, a BitString, or a bitmap. In some aspects, each function can be identified by a Function ID. In some aspects, the one or more functions can be configured and indicated per node, per node group, or to all the nodes in the one or more paths of a mission. The one or more functions may indicate one or more of: a data processing type, a data processing algorithm, a mission, submission, or task information. Some examples of data processing type may include data privacy protection, AI, data sanitization, data normalization, data cleaning, etc. some examples of data processing algorithm may include federating learning (FL), generative adversarial network (GAN), K-anonymity, etc.

In some aspects, a function ID indicated in the function field 912 may identify a function which may further include or be mapped to one or more of: a Mission ID identifying a mission, a submission ID identifying a submission, or a task ID identifying a task.

In some aspects, multiple functions may be configured to one node. Configuring multiple functions at a node may imply that the node needs to perform the functions at different times along different paths. For example, a function field of a packet header associated with mission 800 of FIG. 8A may indicate PF₈₀₂ [function₁, function₂], among other information. Thus, the indication PF₈₀₂ [function₁, function₂] may indicate that node PF 802 needs to perform, one time, function identified by function, for data processing along the first path indicated by solid line 821. Thereafter, PF 802 is to perform, one time, function identified by function2 for data processing along the second path indicated by dotted line 831.

In some aspects, the node IDs and the corresponding functions can be arranged in an order. For example, the function field 912 may indicate {PF 801 ID, [Function 1]; PF 802 ID, [Function 2, Function 3]; . . . ; PFn ID, [Function i, . . . , Function j]}. In said indication, the PF ID identifies a node to execute the corresponding function in [x].

In some aspects, the function field 912 may indicate: {Bitmap, [F1, F2, F3, . . . , Fn]}. The bitmap may indicate the node to execute the corresponding function. For example, if there are 10 node in the network, and the 2^{nd}, 3^{rd}, 5^{th}, 6^{th} and 8^{th} should execute the function F1 to F5, respectively, then the Bitmap can be 10110110 (which indicates the 2^{nd}, 3^{rd}, 5^{th}, 6^{th} and 8^{th} nodes), and the corresponding [F1, F2, F3. . . . F5] are list in sequence.

In some aspects, different nodes may perform different or same function(s). In some aspects, after a node performs a function according to the function field 912, the node may remove the function performed from the packet header, and encapsulate the remaining functions to be performed into the packet header.

As may be appreciated by a person skilled in the art, FIG. 9 is an example format of the improved packet header 900 (e.g., PF packet header). The one or more fields of the packet header 900 may be arranged in different formats. For example, the function field 912 can be located before the BitString field 910. The location of the fields in the packet header is not limited to the illustration in FIG. 9. For example, the function field 912 can be located in the first field, the middle field, or the last field of the packet header, or, the function field 912 may be integrated with other fields (e.g., DSCP field, TC field, OAM field, or BFIR-id field) of the packet header.

FIG. 10 illustrates a procedure for data forwarding and data processing, according to an aspect. Method or procedure 1000 may apply to data forwarding and data processing based on the packet header illustrated in FIG. 9. In an aspect, procedure 1000 may include the control plane (CP) 1026 (e.g., MM or XC) configuring 1001 one or more BIFTs to each network node (e.g., PF 1020, PF 1022, and PF 1025). In some aspects, PF 1020 may be similar to PF 801 of FIG. 8A. In some aspects, PF 1022 may be similar to PF 802 of FIG. 8A. In some aspects PF 1025 may be similar to PF 805 of FIG. 8A.

In some aspects, CP 1026 may configure the one or more BIFT by sending BIFT configuration information to each network node. In some aspects, a number of BIFTs may be configured to one node, and each BIFT may be identified by a BIFT-id.

Each BIFT of a node may indicate or comprise one or more neighbor (NBR) node information and Forwarding Bit Mask (FBM) information for each NBR. The NBR may indicate the next-hop neighbor of the node. FBM may indicates the set of nodes (leaf nodes) that can be reached through the next-hop neighbor when packets are replicated and sent to the next-hop neighbor. In some aspects, the FBM may be a BitString, e.g., Bitmask.

For example, in reference to FIG. 8A, PF 801, PF 802, PF 803 and PF 804 are respectively configured with a first BIFT, e.g., BIFT 1, identified by BIFT-id 1. As illustrated, the entries of different PFs' BIFTs may be different in FIG. 8A. Further, in reference to FIG. 8B, PF 802, PF 805, PF 807 and PF 808 are respectively configured with a second BIFT, BIFT 2, identified by BIFT-id 2. As illustrated, the entries of different PFs' BIFTs may be different in FIG. 8B.

In some aspects, for each BIFT (e.g., BIFT 1, BIFT 2), the BitString identifying each leaf node may be assigned to each leaf node by the control plane 1026. For example, in reference to FIG. 8A and BIFT 1 identified by BIFT-id 1, the leaf nodes are PF 805, PF 806, and their BitString are respectively 0010, and 0001. Similarly, in reference to FIG. 8B, for BIFT 2 identified by BIFT-id 2, the leaf nodes are PF 89, PF 810, and their BitString are respectively 0001, and 0010.

In some aspects, procedure 1000 may further include CP1026 (e.g., MM or XC) sending to the source network node (e.g., the firstly involved PF 1020 of a mission) a message, e.g., a packet header configuration information message 1002 to configure packet header information. The message 1002 may include one or more of: BIFT-id List, TTL List, BSL List, BitString List, BFIR-id List, and Function List.

For example, in reference to FIG. 8A and 8B, the packet header configuration information (which may be sent to the source node PF 801) may indicate a BIFT-id List: BIFT-id 1, BIFT-id 2. In some aspects, the packet header configuration information may further indicate a TTL List: TTL1=3, TTL2=4. In some aspects, the packet header configuration information may further indicate a BSL List: BSL1=4, BSL2=4. In some aspects, the packet header configuration information may further indicate a BitString List: BitString 1=0011 and BitString 2=0011.

Bitstring 1=0011 may indicate leaf nodes PF 805 (0010) and PF 806 (0001) of a first data forwarding path associated with the solid line 821 and based on BIFT 1. Similarly, BitString 2=0011 may indicate leaf nodes, PF 809 (0001) and PF 810 (0010), of a second data forwarding path associated with the dotted line 831 and based on BIFT 2. While in this example BitString 1 and Bitstring 2 are the same, a person skilled in the art may appreciate that the BitStrings may be different.

In reference to FIG. 8A and 8B, in some aspects, the packet header configuration information may further indicate a BFIR-id List: BFIR-id1 identifying PF 801, and BFIR-id2 identifying PF 805. In some aspects, the packet header configuration information may further indicate a function list.

In some aspects, the function list may be indicated according to a first format indication: {PF 801 ID, [F1]; PF 802 ID, [F2, F3]; PF 803 ID, [F4]; PF 804 ID, [F5]; PF 805 ID, [F6, (optional) F7]; PF 806 ID, [F8]; PF 807 ID, [F9]; PF 808 ID, [F10]; PF 809 ID, [F11]; PF 810 ID, [F12]}. The PF ID may refer to the node ID identifying the corresponding PF, and F may refer to Function.

In some aspects, the function list may be indicated according to a second format indication: {Function, [PF 801 ID, PF 802 ID, PF 802 ID, PF 803 ID, PF 804 ID, PF 805 ID, (optional) PF 805 ID, PF 806 ID, PF 807 ID, PF 808 ID, PF 809 ID, PF 810 ID]}. Where the number of a node ID identifying a node included in the packet header may depend on the number of times the node should perform the corresponding function. In some aspects, the function can be a mission identified by a mission ID, or a task identified by a task ID. In some aspects, each node identified by the node ID can acknowledge how it should perform data processing based on the Function (e.g., a mission, a task). For example, each node can acknowledge it should execute a corresponding task (e.g., data privacy protection, AI training, AI inference) of the mission for data processing. In some aspects, for a new source node (e.g., PF 805) starting to perform data forwarding based on a new BIFT, and at the same time, if the new source node needs to perform a new data processing, a new function corresponding to it should be configured, otherwise (i.e., the new source node does not need to perform a new data processing), a new function corresponding to a new data processing should not be configured. Therefore, the second P7 in the first format indication and PF 805 ID in the second format indication above may be optional.

In some aspect, the function list may be indicated according to a third format indication: {bitmap=1111111111, Function=[F1; F2, F3; F4; F5; F6, (optional) F7; F8; F9; F10; F11; F12]}. As may be appreciated by a person skilled in the art, the function list may be indicated according to any reasonable format indication.

In some aspects, the one or more functions to be performed at each node may be configured and indicated per node (as described above in reference to the first format indication and third format indication), per node group, or to all the nodes (as described above in reference to the second format indication) in the path. If the one or more functions are configured to all the nodes in the path, the node ID may be not included in the function list to reduce configuration and data forwarding overhead.

In some aspects, procedure 1000 may further include, the source node, e.g., PF 1020, encapsulating 1003 the configured packet header information into the corresponding filed of a packet header (e.g., packet header 900). In some aspects, encapsulating 1003 may include performing one or more operations. The source node 1020 may perform bitwise AND (&) operation between the configured first BitString of the BitString List and the FBM of each neighbor in the BIFT. If the result is not 0, the current node, e.g., PF 1020, may encapsulate the bitwise AND result into the corresponding “BitString” field (e.g., the field for BitString1) of the packet header. Thereafter the source node may send 1004 the packet to the corresponding neighbor(s).

For example, referring to FIG. 8A, operations at source node PF 801 may include resetting the BitString towards PF 802 to 0011&0011=0011. In some aspects, operations at source node PF 801 may further include resetting the corresponding TTL1=TTL1−1=2, then encapsulating the TTL1 and TTL2 into packet header. In some aspects, operations at source node PF 801 may further include encapsulating the BFIR-id1 identifying PF 801, BFIR-id2 identifying PF 805 into packet header. In some aspects, operations at source node PF 801 may further include, encapsulating BFR-id identifying the next-hop node (e.g., PF 802) in to packet header.

In some aspects, operations at source node PF 801 may further include executing the data processing task indicated by the configured corresponding function. Operations at source node PF 801 may further include removing the used information (e.g., the one or more functions performed by source node to process data) and encapsulating the remaining information of function list (e.g., the one or more functions yet to be performed) into packet header. In some aspects, operations at source node PF 801 may further include encapsulating the data processing result as packet payload into the packet.

For example, in the case that function list is indicated via the first format indication, referring to FIG. 8A, PF 801 may execute the data processing task indicated by F1 (referring to the first format indication of the function list). PF 801 may then remove {PF 801 ID, [F1]} from the function list and encapsulate the other remaining information of function list into packet header, i.e., {PF 802 ID, [F2, F3]; PF 803 ID, [F4]; PF 804 ID, [F5]; PF 805 ID, [F6, (optional) F7]; PF 806 ID, [F8]; PF 807 ID, [F9]; PF 808 ID, [F10]; PF 809 ID, [F11]; PF 810 ID, [F12]}.

In the case that the function list is indicated via the second format indication, after executing the data processing task, PF 801 may remove PF 801 ID from the function list and encapsulate the remaining information of the function list into the packet header: {Function, [PF 802 ID, PF 802 ID, PF 803 ID, PF 804 ID, PF 805 ID, (optional) PF 805 ID, PF 806 ID, PF 807 ID, PF 808 ID, PF 809 ID, PF 810 ID]}.

In some aspects, the procedure 1000 may further include the source node PF 1020 sending the packet 1004 including the packet header and packet payload to the corresponding neighbor (i.e., PF 1022).

In some aspects, after receiving the packet from a previous node, procedure 1000 may further include, each of one or more intermediate network node (e.g., PF 1022 which may be similar to any one of PF 802, PF 803 and PF 804) may perform packet encapsulation 1005. Packet encapsulation may involve one or more operations.

In some aspects, each intermediate node may perform bitwise AND (&) operation between the BitString in the packet header and the FBM of each neighbor in the BIFT. If the result is not 0, the current node may encapsulate the bitwise AND result into the corresponding “BitString” field (e.g., the fields of BitString 1) of the packet header and later sends the packet to the corresponding neighbor(s).

For example, referring to FIG. 8A, operations at node PF 802 may include resetting the BitString towards PF 803 to 0011&0010=0010. Operations at node PF 802 may further include resetting the BitString towards PF 804 to 0011&0011=0011. In some aspects, operations at node PF 802 may further include resetting TTL1=TTL1−1, and then encapsulating the TTL1 and TTL2 into the packet header. For example, PF 802 may reset TTL1=1.

In some aspects, operations at node PF 802 may further include reserving BFIR-id1 identifying PF 801 and BFIR-id2 identifying PF 805 in the packet header. In some aspects, operations at node PF 802 may further include resetting BFR-id to BFR-id identifying a next-hop node (e.g., PF 802 may reset BFR-id to BFR-id identifying PF 803 in the packet toward to PF 803 and reset BFR-id to BFR-id identifying PF 804 in the packet toward to PF 804.

In some aspects, each intermediate node may further execute the data processing task indicated by the corresponding function and then remove the used information (e.g., the one or more functions performed by intermediate node) and encapsulates the other information of Function List (e.g., the one or more functions yet to be performed) into the packet header. Each intermediate node may further, encapsulates the data processing result as packet payload into the packet.

For example, in the case that function list is indicated via the first format indication, referring to FIG. 8A, PF 802 may remove F2 (referring to the first format indication of the function list) and encapsulate the remaining information of function list into the packet toward PF 803 and PF 804. The remaining information of function list may include, for example, {PF 802 ID, [F3]; PF 803 ID, [F4]; PF 804 ID, [F5]; PF 805 ID, [F6, (optional) F7]; PF 806 ID, [F8]; PF 807 ID, [F9]; PF 808 ID, [F10]; PF 809 ID, [F11]; PF 810 ID, [F12]}.

In the case that function list is indicated via the second format indication, after executing the data processing task, PF 802 may remove one PF 802 ID from the function list and encapsulate the reaming information of the function list into the packet header of the packet toward PF 803 and PF 804: {Function, [PF 802 ID, PF 803 ID, PF 804 ID, PF 805 ID, (optional) PF 805 ID, PF 806 ID, PF 807 ID, PF 808 ID, PF 809 ID, PF 810 ID]}.

In some aspects, procedure 1000 may further include, each intermediate node, replicating packet and sending 1006 the packet including the packet header and packet payload to the corresponding neighbor(s), according to BIFT1.

After receiving the packet from previous node, the leaf network node (e.g., PF 1025 and, in reference to FIG. 8A and 8B, PF 806 and PF 805) may perform packet encapsulation 1007. Packet encapsulation may involve one or more operations.

If the BitString in the packet header identifies the leaf node itself and the corresponding TTL of specific value (e.g., TTL1=0), the leaf node may check whether there is a BFIR-id in the BFIR-id list identifying the leaf node. In some aspects, TTL with other specific values may be used to trigger the leaf node to check. For example, as in FIG. 8A and FIG. 8B, if the preliminary TTL1=4, TTL2=5 are configured to the source node (e.g., PF 801, or PF 1020) in message 1002, the specific value TTL=1 will be used. If the preliminary TTL1=3, TTL2=4 are configured to the source node (e.g., PF 801) in message 1002, while only the intermediate nodes (e.g., PF 802, PF 803) other than the source node (e.g., PF 801) reset TTL=TTL−1 in each hop, the specific value TTL=1 will be used. As may be appreciated by a person skilled in the art, the TTL may be used according to any reasonable specific values.

If the leaf node determines that BFIR-id in the BFIR-id list des not identify the leaf node (e.g., BFIR-id indicates another leaf node, or no BFIR-id exists), then the leaf network node (e.g., PF 806) may execute the data processing as per the function list indicated in the packet header, and the procedure 1000 may then come to completion (the leaf node may stop the procedure).

If the leaf node determines that BFIR-id in the BFIR-id list identifies the leaf node, then the leaf network node (e.g., PF 1025 or PF 805) may execute the data processing as per the function list, and further activate as a new source node (i.e., switch from a leaf node to a source node) starting to perform data forwarding based on a new BIFT identified by the next BIFT-id according to the data forwarding sequence.

In some aspects, starting to perform data forwarding may include performing one or more operations. In some aspects, the source node (previously a leaf node with respect to the previous data forwarding path associated with BIFT 1) may remove, from the packet header, information associated with the previous data forwarding path (associated with the BIFT1) including one or more of: expired TTL (e.g., TTL1) and the corresponding BIFT-id (e.g., BIFT-id1), BLS (e.g., BLS1), BFIR-id (BFIR-id1) and BitString (e.g., BitString1).

In some aspects, the leaf network node (active as a new source node) may perform bitwise AND (&) operation between the new BitString (e.g., BitString2=0011) of the BitString List included in the packet header and the FBM of each neighbor in the BIFT identified by the new BIFT-id (e.g., BIFT-id2). If the result is not 0, the current node encapsulates the bitwise AND result into the corresponding “BitString” field (e.g., the field of BitString 2) of the packet header and later sends the packet to the corresponding neighbor(s). For example, in reference to FIG. 8B, the operation at node PF 805 may include resetting the BitString towards PF 807 to 0011&0011=0011.

Operations at node PF 805 may further include resetting the corresponding TTL2=TTL2−1=3, and further encapsulating the TTL2 into the packet header. Operations at node PF 805 may further include encapsulating the BFIR-id2 identifying PF 805 into packet header. Operations at node PF 805 may further include encapsulating BFR-id identifying the next-hop node (e.g., PF 807) into the packet header.

In some aspects, the leaf network node (active as the new source node) (e.g., PF 1025 or 805) may execute the data processing task indicated by the configured corresponding function. The leaf node may then remove the used information (e.g., the one or more functions performed by the leaf node (active as the new source node) to process data) and encapsulate the remaining information of function list (e.g., the one or more functions yet to be performed) into packet header. In some aspects, the leaf node active as a source node may encapsulate the data processing result as packet payload into the packet.

In some aspects, the procedure 1000 may further include the leaf network node (active as a new source node) (e.g., PF 1025 or PF 805) sending the packet 1008 including the packet header and packet payload to the corresponding neighbor (i.e., PF 1022 or PF 807).

In some aspects, the procedure 1000 may further include, each of the intermediate nodes (e.g., in reference to FIG. 8B, PF 807 and PF 808), leaf node (PF 809, PF 810), or a new source node performing data forwarding and data processing based on the information included in the packet header according to corresponding operations described herein, until all TTLs turn to 0. Thereafter, the procedure 1000 may come to completion.

In some aspects, the control plane may be involved in one or both of per-flow and per tunnel traffic steering in loop transmissions. In some aspects, e.g., in reference to FIGS. 11 and 13, an improved packet header comprising enhanced information in addition to information in a BIER packet header may be provided and leveraged into a PF packet header of PF protocol layer.

FIG. 11 illustrates another procedure for data forwarding and data processing, according to an aspect. According to an aspect, procedure 1100 may include the CP 1126 (e.g., MM or XC) configuring 1101 one or more BIFTs to each network node (e.g., PF 1120, PF 1122, and PF 1125). The configuring operation 1101 may be similar to the configuring operation 1001 of FIG. 10.

In some aspects, PF 1120 may be similar to PF 801 of FIG. 8A. In some aspects, PF 1122 may be similar to PF 802 of FIG. 8A. In some aspects PF 1125 may be similar to PF 805 of FIG. 8A.

In some aspects, CP 1126 may configure the one or more BIFT by sending BIFT configuration information to each network node. In some aspects, a number of BIFTs may be configured to one node, and each BIFT may be identified by a BIFT-id.

Each BIFT of a node may indicate or comprise one or more neighbor (NBR) node information and Forwarding Bit Mask (FBM) information for each NBR. The NBR may indicate the next-hop neighbor of the node. FBM may indicates the set of nodes (leaf nodes) that can be reached through the next-hop neighbor when packets are replicated and sent to the next-hop neighbor. In some aspects, the FBM may be a BitString, e.g., Bitmask.

For example, in reference to FIG. 8A, PF 801, PF 802, PF 803 and PF 804 are respectively configured with a first BIFT, e.g., BIFT 1, identified by BIFT-id 1. As illustrated, the entries of different PFs' BIFTs may be different in FIG. 8A. Further, in reference to FIG. 8B, PF 802, PF 805, PF 807 and PF 808 are respectively configured with a second BIFT, BIFT 2, identified by BIFT-id 2. As illustrated, the entries of different PFs' BIFTs may be different in FIG. 8B.

In some aspects, for each BIFT (e.g., BIFT 1, BIFT 2), the BitString identifying each leaf node may be assigned to each leaf node by the control plane 1126. For example, in reference to FIG. 8A and BIFT 1 identified by BIFT-id 1, the leaf nodes are PF 805, PF 806, and their BitString are respectively 0010, and 0001. Similarly, in reference to FIG. 8B, for BIFT 2 identified by BIFT-id 2, the leaf nodes are PF 89, PF 810, and their BitString are respectively 0001, and 0010.

In some aspects, procedure 1100 may further include CP (e.g., MM or XC) sending to the source network node (e.g., the firstly involved PF 1120 of a mission) a message, e.g., a packet header configuration information message 1102 to configure packet header information. In some aspects, the message 1102 may include one or more of: BIFT-id, TTL, BSL, BitString, BFIR-id, Function List.

For example, in reference to FIG. 8A, the packet header configuration information (sent to the source node PF 801) may indicate BIFT-id: BIFT-id1. In some aspects, the packet header configuration information may further indicate TTL: TTL 1=3. In some aspects, the packet header configuration information may further indicate BSL: BSL1=4. In some aspects, the packet header configuration information may further indicate BitString: BitString 1=0011. In some aspects, the packet header configuration information may further indicate BFIR-id: BFIR-id1 identifying PF 801.

In some aspects, the packet header configuration information may further indicate a function list. In some aspects, the function list may be indicated according to a first format indication: {PF 801 ID, F1; PF 802 ID, F2; PF 803 ID, F4; PF 804 ID, F5; PF 805 ID, F6; PF 806 ID, F8}. The PF ID may refer to the node ID identifying the corresponding PF. In some aspects, the PF ID can be the BFR-id. The ‘F’ in the first format indication may refer to the function.

In some aspects, the function list may be indicated according to a second format indication: {Function, [PF 801 ID, PF 802 ID, PF 803 ID, PF 804 ID, PF 805 ID, PF 806 ID]}.

In some aspects, the function can be a mission identified by a mission ID, or a task identified by a task ID. In some aspects, each node identified by the node ID can acknowledge how it should perform data processing based on the Function (e.g., a mission, a task). For example, each node can acknowledge it should execute a corresponding task (e.g., data privacy protection, AI training, AI inference) of the mission for data processing.

In some aspect, the function list may be indicated according to a third format indication: {bitmap=0000111111, Function=[F1; F2; F4; F5; F6; F8]}. As may be appreciated by a person skilled in the art, the function list may be indicated according to any reasonable format indication.

In some aspects, the one or more functions to be performed at each node may be configured and indicated per node (as described above in reference to the first format indication and third format indication), per node group, or to all the nodes (as described above in reference to the second format indication) in the path. If the one or more functions are configured to all the nodes in the path, the node ID may be not included in the function list to reduce configuration and data forwarding overhead.

In some aspects, the packet header configuration information message 1102 may be for a first data forwarding path of a mission. Thus, the message 1102 may include relevant information for the first data forwarding path.

In some aspects, procedure 1100 may further include CP 1126 (e.g., MM or XC) sending to a leaf node (e.g., PF 1125), which may later activate as a new source network node (i.e., switch from a leaf node to a source node), a second packet header configuration information message 1103 to configure packet header information. The message 1103 may include one or more of: BIFT-id, TTL, BSL, BitString, BFIR-id, switch instruction information, and Function List. The second packet header configuration information message may be for a second data forwarding path of the mission, and thus may include relevant information for the second data forwarding path.

For example, in reference to FIG. 8B, the second packet header configuration information (which may be sent to the leaf node (of the first data forwarding path) PF 805 later acting as a source node for a second data forwarding path) may indicate one or more of: BIFT-id: BIFT-id2, TTL: TTL2=4, BSL: BSL2=4, BitString: BitString 2=0011, BFIR-id: BFIR-id2 identifying PF 805.

In some aspects, the second packet header configuration information may further indicate a function list. In some aspects, the function list may be indicated according toa first format indication: {PF 802 ID, F2; PF 805 ID, (optional) F7; PF 807 ID, F9; PF 808 ID, F10; PF 809 ID, F11; PF 810 ID, F12}. The PF ID may refer to the node ID identifying the corresponding PF. In some aspects, the PF ID can be the BFR-id. The ‘F’ in the first format indication may refer to the function.

In some aspects, the function list may be indicated according to a second format indication: {Function, [PF 802 ID, (optional) PF 805 ID, PF 807 ID, PF 808 ID, PF 809 ID, PF 810 ID]}. In some aspects, the function can be a mission identified by a mission ID, or a task identified by a task ID. In some aspects, each node identified by the node ID can acknowledge how it should perform data processing based on the Function (e.g., a mission, a task). For example, each node can acknowledge it should execute a corresponding task (e.g., data privacy protection, AI training, AI inference) of the mission for data processing.

In some aspect, the function list may be indicated according to a third format indication: {bitmap=1111110010, Function=[F3; F5, (optional) F7; F8; F9; F10; F11; F12]}. As may be appreciated by a person skilled in the art, the function list may be indicated according to any reasonable format indication.

In some aspects, the one or more functions to be performed at each node may be configured and indicated per node (as described above in reference to the first format indication and third format indication), per node group, or to all the nodes (as described above in reference to the second format indication) in the path. If the one or more functions are configured to all the nodes in the path, the node ID may be not included in the function list to reduce configuration and data forwarding overhead.

In some aspects, the switch instruction information may include an indication indicating to switch from a leaf node to a source node when the switching conditions are satisfied. For example, the switching indication may indicate that the node (e.g., PF 805) identified by the BFIR-id (e.g., BFIR-id2) included in this message 1103 need to activate as a new source node (i.e., switch from a leaf node of the first data forwarding path to a source node of the second data forwarding path) when the TTL=0 (e.g., TTL=0) is included in a received packet header of a packet. As may be appreciated by a person skilled in the art, the TTL may be included according to any reasonable specific values.

In some aspects, the switch instruction information may include a BFIR-id (e.g., BFIR-id1) identifying a previous source node (e.g., PF 801), a BIFT-id (e.g., BIFT-id1) identifying a previous BIFT. The switch instruction information may indicate that when TTL=0, BFIR-id1 and BIFT-id1 are included in the packet header, the node (e.g., PF 805) identified by the BFIR-id (e.g., BFIR-id2, PF ID) included in this message 1103 need activate as a new source node (i.e., switch from a leaf node to a source node).

In some aspects, procedure 1100 may further include the source network node (e.g., PF 1120) encapsulating 1104 the configured packet header information into the corresponding field of packet header. In some aspects, encapsulating 1104 may include performing one or more operations as described herein.

In some aspects, the source node 1120 may perform bitwise AND (&) operation between the configured BitString: BitString 1=0011 and the FBM of each neighbor in the BIFT identified by BIFT1. If the result is not 0, the current node, e.g., PF 1120, may encapsulate the bitwise AND result into the corresponding “BitString” field of the packet header and later sends the packet to the corresponding neighbor(s).

For example, referring to FIG. 8A, operations at source node PF 801 may include resetting the BitString towards PF 802 to 0011&0011=0011. In some aspects, operations at source node PF 801 may further include resetting the corresponding TTL: TTL1=TTL1−1=2, then encapsulating the TTL: TTL1 into packet header.

In some aspects, operations at source node PF 801 may further include encapsulating one or both of: the BFIR-id1 identifying PF 801, and BFIR-id2 identifying PF 805 into packet header. PF 801 may obtain BFIR-id2 identifying PF 805 via various ways, e.g., the BFIR-id2 identifying PF 805 may be pre-configured to PF 801 and stored locally. In some aspects, operations at source node PF 801 may further include encapsulating BFR-id identifying the next-hop node (e.g., PF 802) into the packet header.

In some aspects, operations at source node PF 801 may further include the source node (e.g., PF 801) executing the data processing task indicated by the configured corresponding Function. Operations at source node PF 801 may further include removing the used information (e.g., the one or more functions performed by source node to process data) and encapsulating the other information of Function List (e.g., the one or more functions yet to be performed) into packet header. In some aspects, operations at source node PF 801 may further include encapsulating the data processing result as packet payload into the packet.

For example, in the case that function list is indicated via the first format indication, referring to FIG. 8A, PF 801 may execute the data processing task indicated by F1 (referring to the first format indication of the function list). PF 801 may then remove {PF 801 ID, [F1]} from the function list and encapsulate the other remaining information of function list into packet header, i.e., {PF 802 ID, F2; PF 803 ID, F4; PF 804 ID, F5; PF 805 ID, F6; PF 806 ID, F8}.

In the case that the function list is indicated via the second format indication, after executing the data processing task, PF 801 may remove PF 801 ID from the function list and encapsulate the remaining information of the function list into the packet header toward PF 802: {Function, [PF 802 ID, PF 803 ID, PF 804 ID, PF 805 ID, PF 806 ID]}.

Similarly, in the case that the function list is indicated via the third format indication, PF 801 may set the value of its bit space to 0, remove the corresponding function and encapsulate {bitmap=0000111110, Function=[F2; F4; F5; F6; F8]} into the packet towards PF 802.

In some aspects, the procedure 1000 may further include the source node PF 1120 sending the packet 1105 including the packet header and packet payload to the corresponding neighbor (i.e., PF 1122).

In some aspects, after receiving the packet from a previous node, procedure 1100 may further include, each of one or more intermediate network nodes (e.g., PF 1102 which may be similar to any of PF 802, PF 803, and PF 804) may perform packet encapsulation 1106. Packet encapsulation may involve one or more operations.

In some aspects, each network node may perform bitwise AND (&) operation between the BitString in the packet header and the FBM of each neighbor in the BIFT. If the result is not 0, the current node encapsulates the bitwise AND result into the corresponding “BitString” field (e.g., the fields of BitString 1) of the packet header and later sends the packet to the corresponding neighbor(s).

For example, referring to FIG. 8A, operations at node PF 802 may include resetting the BitString towards PF 803 to 0011&0010=0010. Operations at node PF 802 may further include resetting the BitString towards PF 804 to 0011&0011=0011. In some aspects, operations at node PF 802 may further include resetting TTL1=TTL1−1, and then encapsulating the TTL1 into the packet header. For example, PF 802 may reset TTL1=1.

In some aspects, operations at node PF 802 may further include reserving BFIR-id1 identifying PF 801 in the packet header. In some aspects, operations at node PF 802 may further include reserving BFIR-id2 identifying PF 805 in the packet header.

In some aspects, operations at node PF 802 may further include resetting the next-hop node ID (e.g., BFR-id) to an ID identifying the next-hop node. For example, PF 802 may reset the next-hop node ID to the ID identifying PF 803 in the packet toward PF 803. Similarly, in the packet toward PF 804, PF 802 may reset the next-hop node ID to the ID identifying PF 804.

In some aspects, each intermediate node may further execute the data processing task indicated by the corresponding function and then remove the used information (e.g., the one or more functions performed by intermediate node) and encapsulate the remaining information of Function List (e.g., the one or more functions yet to be performed) into the packet header. Each intermediate node may further, encapsulates the data processing result as packet payload into the packet.

For example, in the case that function list is indicated via the first format indication, referring to FIG. 8A, PF 802 may remove F2 (referring to the first format indication of the function list) and encapsulate the remaining information of function list into the packet toward PF 803 and PF 804. The remaining information of function list may include, for example, {PF 803 ID, F4; PF 804 ID, F5; PF 805 ID, F6; PF 806 ID, F8}.

In the case that the function list is indicated via the second format indication, after executing the data processing task, PF 802 may remove PF 802 ID from the function list and encapsulate the remaining information of the function list into the packet header toward PF 803 and PF 804: {Function, [PF 803 ID, PF 804 ID, PF 805 ID, PF 806 ID]}.

Similarly, in the case that the function list is indicated via the third format indication, PF 802 may set the value of its bit space to 0, remove the corresponding function and encapsulate {bitmap=0000111100, Function=[F4; F5; F6; F8]} into the packet towards PF 803 and PF 804.

In some aspects, procedure 1100 may further include, each intermediate node replicating packet and sending the packet 1107 including the packet header and packet payload to the corresponding neighbor(s).

After receiving packet from previous node, procedure 1100 may further include, each of one or more leaf network nodes (e.g., PF 1125, and in reference to FIG. 8A and 8B, PF 806 and PF 805) performing 1108 one or more operations.

If the BitString in the packet header identifies the leaf node itself and the corresponding TTL=0, the leaf node may check whether the information included in the packet header satisfy the switching conditions as per the configured switch instruction information. For example, the switch condition is satisfied when the leaf node (which received the packet configuration at 1103) receives a packet indicating: TTL=0, BIFT-id1 (e.g., BIFT-id1) identifying a previous BIFT, and BFIR-id1 identifying a previous source node (e.g., PF 801).

If the leaf node determines that the switch condition is not satisfied, then the leaf network node (e.g., PF 806) may execute the data processing as per the function list indicated in the packet header, and the procedure 1100 may then come to completion (the leaf node may stop the procedure).

If the leaf node determines that the switch condition is satisfied, then the leaf network node (e.g., PF 1125 or PF 805) may execute the data processing as per the function list, and further activate as a new source node (i.e., switch from a leaf node to a source node) starting to perform data forwarding based on a new BIFT identified by the next BIFT-id (e.g., the BIFT-id: BIFT-id2 included in the second packet header configuration information configured via message 1103) according to the data forwarding sequence.

In some aspects, starting to perform data forwarding may include performing one or more operations. In some aspects, the source node (previously a leaf node with respect to the previous data forwarding path associated with BIFT 1) may remove, from the packet header, information associated with the previous data forwarding path (associated with the BIFT1) including one or more of: expired TTL (e.g., TTL1) and the corresponding BIFT-id (e.g., BIFT-id1), BLS (e.g., BLS1), BFIR-id (BFIR-id1) and BitString (e.g., BitString1).

In some aspects, the leaf network node (active as a new source node) may perform bitwise AND (&) operation between the new BitString (e.g., BitString2 =0011) and the FBM of each neighbor in the BIFT identified by the new BIFT-id (e.g., BIFT-id2). If the result is not 0, the current node (e.g., PF 1125 or PF 805) may encapsulate the bitwise AND result into the corresponding “BitString” field of the packet header and later sends the packet to the corresponding neighbor(s).

For example, in reference to FIG. 8B, operations at node PF 805 may include resetting the BitString towards PF 807 to 0011&0011=0011. Operations at node PF 805 may further include resetting the corresponding TTL2=TTL2−1=3, and further encapsulating the TTL2 into the packet header. Operations at node PF 805 may further include encapsulating the BFIR-id2 identifying PF 805 into packet header. Operations at node PF 805 may further include encapsulating BFR-id identifying the next-hop node (e.g., PF 807) into the packet header.

In some aspects, the leaf network node (active as the new source node) (e.g., PF 1125 or 805) may execute the data processing task indicated by the configured corresponding function (e.g., the function list in the second packet header configuration information message 1104). The leaf node may then remove the used information (e.g., the one or more functions performed by the leaf node (active as the new source node) to process data) and encapsulate the remaining information of function list (e.g., the one or more functions yet to be performed) into packet header. In some aspects, the leaf node active as a source node may encapsulate the data processing result as packet payload into the packet.

In some aspects, the procedure 1100 may further include the leaf network node (active as a new source node) (e.g., PF 1125 or PF 805) sending the packet 1109 including the packet header and packet payload to the corresponding neighbor (i.e., PF 1022 or PF 807).

In some aspects, the procedure 1100 may further include, each of the intermediate nodes (e.g., in reference to FIG. 8B, PF 807 and PF 808), leaf node (PF 809, PF 810), or a new source node performing data forwarding and data processing based on the information included in the packet header according to corresponding operations described herein, until all TTLs turn to 0. Thereafter, the procedure 1100 may come to completion.

FIG. 12 illustrates a PF packet header, according to an aspect. The packet header 1200 may be an improvement to the BIER packet header. The packet header 1200 may be a packet header of a PF PDU. In some aspects, the packet header 1200 can be applied in any suitable protocol layer, e.g., IP protocol layer, protocol layer on top of transport layer or network layer, the proposed PF protocol layer.

In some aspects, packet header 1200 may be leveraged it into the PF protocol layer. The packet header 1200 may include a plurality of fields indicating one or more of: BIFT-id, traffic class (TC), S bit of label stack (S), TTL, Nibble, version number (Ver), Entropy for load balancing purposes, Query indication 1202, OAM, Rsv, DSCP, Proto, BFIR-id 1204, Bitstring, and function 1206.

The Query indication field 1202 may indicate that a leaf node should send a query message to the CP (e.g., a CP function) requesting for further instructions when the leaf node receives a packet including a packet header indicating one or more of: a TTL indicating a completion of a packet's last hop of the first data path (e.g., TTL=0), and a source node ID (e.g., BFIR-id) identifying the leaf node as a new source node for initiating a new data path.

In some aspects, the BFIR-id field 1204 may be similar to the BFIR-id field 908. The BFIR-id field 1204 may indicate a BFIR-id list including more than one BFIR-ids. Each of the BFIR-ids may identify a source node (e.g., source PF) starting or initiating to perform data forwarding (e.g., a data forwarding path) based on a new BIFT. Thus, each BFIR-id may indicate the source node for initiating a path (e.g., a data path) corresponding to the new BIFT-id.

In some aspects, the BFIR-ids of the BIFR-id list, except the first BFIR-id, may identify the nodes which should switch from a leaf node to a source node. If a node receives a packet including a TTL with a specific value (e.g., TTL=0) and a BFIR-id identifying the node, then the node acknowledges that it is a source node starting to perform data forwarding based on a new BIFT identified by the next BIFT-id. Accordingly, the node may encapsulate the next BIFT-id and the next corresponding TTL into the packet header to be forwarded to next hop.

In some aspects, the function field 1206 may be similar to the function field 912. The function field 1206 may indicate one or more functions in a form of a function list. In some aspects, the one or more functions indicated via the function field 912 may be used for Data Processing Configuration, indicating the approach (e.g., the function) that a corresponding node needs to take for data processing. In some aspects, the corresponding node can be identified by a node ID, e.g., a BFIR-id, a PF ID, a BitString, or a bitmap. In some aspects, each function can be identified by a Function ID. In some aspects, the one or more functions can be configured and indicated per node, per node group, or to all the nodes in the one or more paths of a mission. The one or more functions may indicate one or more of: a data processing type, a data processing algorithm, a mission, submission, or task information. Some examples of data processing type may include data privacy protection, AI, data sanitization, data normalization, data cleaning, etc. some examples of data processing algorithm may include federating learning (FL), generative adversarial network (GAN), K-anonymity, etc.

In some aspects, a function ID indicated in the function field 1206 may identify a function which may further include or be mapped to one or more of: a Mission ID identifying a mission, a submission ID identifying a submission, or a task ID identifying a task. In some aspects, multiple functions may be configured to one node. Configuring multiple functions at a node may imply that the node needs to perform the functions at different times along different paths.

According to an aspect, a scheme may be provided that involves the control plane for one or both of per-flow and per-tunnel traffic steering in loop transmission. The scheme may use an improved packet header 1200 to accommodate data forwarding and data processing as described herein. In some aspects, the packet header 1200 may be leverage into the PF packet header of PF protocol layer.

FIG. 13 illustrates another procedure for data forwarding and data processing, according to an aspect. Procedure 1300 may include the CP 1326 (e.g., MM or XC) configuring 1301 one or more BIFTs to each network node (e.g., PF 1320, PF 1322, and PF 1325). The configuring operation 1301 may be similar to the configuring operation 1101 of FIG. 11 configuration operation 1001 of FIG. 10.

In some aspects, PF 1320 may be similar to PF 801 of FIG. 8A. In some aspects, PF 1322 may be similar to PF 802 of FIG. 8A. In some aspects PF 1325 may be similar to PF 805 of FIG. 8A.

In some aspects, CP 1326 may configure the one or more BIFT by sending BIFT configuration information to each network node. In some aspects, a number of BIFTs may be configured to one node, and each BIFT may be identified by a BIFT-id.

Each BIFT of a node may indicate or comprise one or more neighbor (NBR) node information and Forwarding Bit Mask (FBM) information for each NBR. The NBR may indicate the next-hop neighbor of the node. FBM may indicates the set of nodes (leaf nodes) that can be reached through the next-hop neighbor when packets are replicated and sent to the next-hop neighbor. In some aspects, the FBM may be a BitString, e.g., Bitmask.

For example, in reference to FIG. 8A, PF 801, PF 802, PF 803 and PF 804 are respectively configured with a first BIFT, e.g., BIFT 1, identified by BIFT-id 1. As illustrated, the entries of different PFs' BIFTs may be different in FIG. 8A. Further, in reference to FIG. 8B, PF 802, PF 805, PF 807 and PF 808 are respectively configured with a second BIFT, BIFT 2, identified by BIFT-id 2. As illustrated, the entries of different PFs' BIFTs may be different in FIG. 8B.

In some aspects, for each BIFT (e.g., BIFT 1, BIFT 2), the BitString identifying each leaf node may be assigned to each leaf node by the control plane 1126. For example, in reference to FIG. 8A and BIFT 1 identified by BIFT-id 1, the leaf nodes are PF 805, PF 806, and their BitString are respectively 0010, and 0001. Similarly, in reference to FIG. 8B, for BIFT 2 identified by BIFT-id 2, the leaf nodes are PF 89, PF 810, and their BitString are respectively 0001, and 0010.

In some aspects, procedure 1300 may further include CP (e.g., MM or XC) sending to the source network node (e.g., the firstly involved PF 1320 of a mission) a packet header configuration information message 1302 to configure packet header information. In some aspects, the message 1302 may include one or more of: BIFT-id, TTL, BSL, BitString, BFIR-id, (optional) Function List, and query indication.

In some aspects, the packet header configuration information message 1302 may be for a first data forwarding path of the mission. Thus, the message 1302 may include the relevant information for the first data forwarding path.

The query indication (QI) may indicate that a leaf node should send a query message to the CP requesting for the next-step instruction when the leaf node receives a packet including a packet header indicating one or both of: a TTL indicating a completion of a packet's last hop of the first data path (e.g., TTL=0), and a source node ID (e.g., PF ID, BFIR-id) identifying the leaf node as a second source node for initiating a second data path of the mission. Thus, the node ID (e.g., PF ID, BFIR-id) included in the message 1302 may identify the leaf node that may need to switch from a leaf node to a source node of the second data path.

In some aspects, the QI can be a Boolean value. For example, a QI value being 1 may indicate that a leaf node need send a query message to CP for the next-step instruction when TTL=0. Similarly, a QI value being 0 (or lack of a QI value or QI) may indicate that a leaf node need not send a query message to CP for the next-step instruction when TTL=0.

In some aspects, the QI may be a bitmap. For example, the bitmap may indicate one or more leaf nodes which need to send a query message to CP for the next-step instruction when TTL=0. For example, in reference to FIG. 8A, leaf node PF 805 may need to send a query message to CP since PF 805 is also a source node for the second data forwarding path as illustrated in FIG. 8B. Whereas leaf node PF 806 does not need to send a query message to CP since PF 806 is not involved in (e.g., not a source node for) the second data forwarding path. Accordingly, in reference to FIG. 8A and 8B with respect to PF 805 and PF 806, the bitmap indicating QI may be set to 0010. If both PF 805 and PF 806 need to send the query message, then the bitmap can be set to 0011.

As described, BFIR-id may identify the leaf node which need to activate as a new source node (i.e., switch from a leaf node to a source node) and send the query message to the CP for the next-step instruction when the TTL=0. Identifying the leaf node and switching from a leaf node to a source node applies to nodes other than the first BFIR-id (e.g., BFIR-id1) since the first BFIR-id identifies the first source node, whereas, for example, the second BFIR-id identifies the second source node. In some aspects, inclusion of BFIR-id is optional. For example, if the QI indicates the one or more leaf nodes which need to send a query message to CP for the next-step instruction when TTL=0, the BFIR-id may not be needed. Otherwise, if the QI does not indicate or identify the one or more leaf nodes that need to send a query message to CP, then the BFIR-id may be needed. In some aspects, the BFIR-id can be the ID of the leaf nodes, e.g., the BitString identifying the leaf node.

For example, in reference to FIG. 8A, the packet header configuration information (sent to the source node PF 801) may indicate BIFT-id: BIFT-id1. In some aspects, the packet header configuration information may further indicate TTL: TTL 1=3. In some aspects, the packet header configuration information may further indicate BSL: BSL1=4. In some aspects, the packet header configuration information may further indicate BitString: BitString 1=0011. In some aspects, the packet header configuration information may further indicate BFIR-id: BFIR-id1 identifying PF 801 or other PF IDs identifying PF 801.

In some aspects, the packet header configuration information may further indicate a function list. In some aspects, the function list may be indicated according to a first format indication: {PF 801 ID, F1; PF 802 ID, F2; PF 803 ID, F4; PF 804 ID, F5; PF 805 ID, F6; PF 806 ID, F8}. The PF ID may refer to the node ID identifying the corresponding PF. In some aspects, the PF ID can be the BFR-id. The ‘F’ in the first format indication may refer to the function.

In some aspects, the function list may be indicated according to a second format indication: {Function, [PF 801 ID, PF 802 ID, PF 803 ID, PF 804 ID, PF 805 ID, PF 806 ID]}. In some aspects, the function can be a mission identified by a mission ID, or a task identified by a task ID. In some aspects, each node identified by the node ID can acknowledge how it should perform data processing based on the Function (e.g., a mission, a task). For example, each node can acknowledge it should execute a corresponding task (e.g., data privacy protection, AI training, AI inference) of the mission for data processing.

In some aspect, the function list may be indicated according to a third format indication: {bitmap=0000111111, Function=[F1; F2; F4; F5; F6; F8]}. As may be appreciated by a person skilled in the art, the function list may be indicated according to any reasonable format indication.

In some aspects, the one or more functions to be performed at each node may be configured and indicated per node (as described above in reference to the first format indication and third format indication), per node group, or to all the nodes (as described above in reference to the second format indication) in the path. If the one or more functions are configured to all the nodes in the path, the node ID may be not included in the function list to reduce configuration and data forwarding overhead.

In some aspects, the packet header configuration information may further indicate the QI, which, as described, may indicate that the one or more leaf node that should send a query message to the CP for the next-step instruction when the TTL (e.g., TTL=0) indicates a completion of a packet's last hop of the previous data path. In some aspects, the packet header configuration information 1302 may further indicate the BFIR-id (e.g., BFIR-id2, or BitString 0010) identifying the leaf node (e.g., PF 805 in reference to FIG. 8A and 8B) which need to activate as a new source node and send query message to the CP for the next-step instruction when the TTL=0. Other leaf nodes (e.g., PF 806) may not need to send the query message to CP for next-step instructions, and the corresponding BFIR-id need not be configured. By indicating the one or more leaf nodes (e.g., PF 805) that need to switch to or activate as source nodes, and thereby not requiring the other leaf nodes (e.g., PF 806) to send a query message to CP, may reduce the control signalling storm between the leaf nodes and CP.

In some aspects, procedure 1300 may further include the source network node (e.g., PF 1320) encapsulating 1303 the configured packet header information into the corresponding field of packet header. In some aspects, the packet header into which PF 1320 encapsulates 1303 the configured packet header information may be similar to packet header 1200. In some aspects, encapsulating 1303 may include performing one or more operations as described herein.

In some aspects, the source node 1320 may perform bitwise AND (&) operation between the configured BitString: BitString 1=0011 and the FBM of each neighbor in the BIFT identified by BIFT1. If the result is not 0, the current node, e.g., PF 1320, may encapsulate the bitwise AND result into the corresponding “BitString” field of the packet header and later sends the packet to the corresponding neighbor(s).

For example, referring to FIG. 8A, operations at source node PF 801 may include resetting the BitString towards PF 802 to 0011&0011=0011. In some aspects, operations at source node PF 801 may further include resetting the corresponding TTL: TTL1=TTL1−1=2, then encapsulating the TTL: TTL1 into packet header.

In some aspects, operations at source node PF 801 may further include encapsulating one or both of: the BFIR-id1 identifying PF 801, and BFIR-id2 identifying PF 805 into packet header. PF 801 may obtain BFIR-id2 identifying PF 805 via various ways, e.g., the BFIR-id2 identifying PF 805 may be pre-configured to PF 801 and stored locally. In some aspects, operations at source node PF 801 may further include encapsulating BFR-id identifying the next-hop node (e.g., PF 802) into the packet header.

In some aspects, operations at source node PF 801 may further include the source node (e.g., PF 801) executing the data processing task indicated by the configured corresponding Function. Operations at source node PF 801 may further include removing the used information (e.g., the one or more functions performed by source node to process data) and encapsulating the other information of Function List (e.g., the one or more functions yet to be performed) into packet header. In some aspects, operations at source node PF 801 may further include encapsulating the data processing result as packet payload into the packet.

For example, in the case that function list is indicated via the first format indication, referring to FIG. 8A, PF 801 may execute the data processing task indicated by F1 (referring to the first format indication of the function list). PF 801 may then remove {PF 801 ID, [F1]} from the function list and encapsulate the other remaining information of function list into packet header, i.e., {PF 802 ID, F2; PF 803 ID, F4; PF 804 ID, F5; PF 805 ID, F6; PF 806 ID, F8}.

In the case that the function list is indicated via the second format indication, after executing the data processing task, PF 801 may remove PF 801 ID from the function list and encapsulate the remaining information of the function list into the packet header toward PF 802: {Function, [PF 802 ID, PF 803 ID, PF 804 ID, PF 805 ID, PF 806 ID]}.

Similarly, in the case that the function list is indicated via the third format indication, PF 801 may set the value of its bit space to 0, remove the corresponding function and encapsulate {bitmap=0000111110, Function=[F2; F4; F5; F6; F8]} into the packet towards PF 802.

In some aspects, the procedure 1300 may further include the source node PF 1320 sending the packet 1304 including the packet header and packet payload to the corresponding neighbor (i.e., PF 1322).

In some aspects, after receiving the packet from a previous node, procedure 1300 may further include, each of one or more intermediate network nodes (e.g., PF 1302 which may be similar to any of PF 802, PF 803, and PF 804) may perform packet encapsulation 1305. Packet encapsulation 1305 may involve one or more operations as described herein.

In some aspects, each network node may perform bitwise AND (&) operation between the BitString in the packet header and the FBM of each neighbor in the BIFT. If the result is not 0, the current node encapsulates the bitwise AND result into the corresponding “BitString” field (e.g., the fields of BitString 1) of the packet header and later sends the packet to the corresponding neighbor(s).

For example, referring to FIG. 8A, operations at node PF 802 may include resetting the BitString towards PF 803 to 0011&0010=0010. Operations at node PF 802 may further include resetting the BitString towards PF 804 to 0011&0011=0011. In some aspects, operations at node PF 802 may further include resetting TTL1=TTL1−1, and then encapsulating the TTL1 into the packet header. For example, PF 802 may reset TTL1=1.

In some aspects, operations at node PF 802 may further include reserving BFIR-id1 identifying PF 801 in the packet header. In some aspects, operations at node PF 802 may further include reserving BFIR-id2 identifying PF 805 in the packet header.

In some aspects, operations at node PF 802 may further include resetting the next-hop node ID (e.g., BFR-id) to an ID (e.g., BFR-id) identifying the next hop node. For example, PF 802 may reset the BFR-id to BFR-id identifying PF 803 in the packet toward PF 803. Similarly, in the packet toward PF 804, PF 802 may reset BFR-id to BFR-id identifying PF 804.

In some aspects, each intermediate node may further execute the data processing task indicated by the corresponding function and then remove the used information (e.g., the one or more functions performed by intermediate node) and encapsulate the remaining information of Function List (e.g., the one or more functions yet to be performed) into the packet header. Each intermediate node may further, encapsulates the data processing result as packet payload into the packet.

For example, in the case that function list is indicated via the first format indication,

referring to FIG. 8A, PF 802 may remove F2 (referring to the first format indication of the function list) and encapsulate the remaining information of function list into the packet toward

PF 803 and PF 804. The remaining information of function list may include, for example, {PF 803 ID, F4; PF 804 ID, F5; PF 805 ID, F6; PF 806 ID, F8}.

In the case that the function list is indicated via the second format indication, after executing the data processing task, PF 802 may remove PF 802 ID from the function list and encapsulate the remaining information of the function list into the packet header toward PF 803 and PF 804: {Function, [PF 803 ID, PF 804 ID, PF 805 ID, PF 806 ID]}.

Similarly, in the case that the function list is indicated via the third format indication, PF 802 may set the value of its bit space to 0, remove the corresponding function and encapsulate {bitmap=0000111100, Function=[F4; F5; F6; F8]} into the packet towards PF 803 and PF 804.

In some aspects, procedure 1300 may further include, each intermediate node replicating the packet and sending the packet 1306 including the packet header and packet payload to the corresponding neighbor(s).

In some aspects, after receiving the packet from a previous node, procedure 1300 may further include, each of one or more leaf network nodes (e.g., PF 1325, and in reference to FIG. 8A and 8B, PF 806 and PF 805) performing one or more operations.

In some aspects, the QI (e.g., being a Boolean value=1) configured at PF 1320 via the packet header configuration information message 1302 may not identify one or more leaf nodes. In such aspects, if the packet header in the received (by a leaf node) packet indicates one or more of: a BitString identifying the leaf node, a TTL indicator indicating a completion of the packet's last hop of the first data path (e.g., TTL=0), and the QI, the leaf node (e.g., PF 1325, PF 806, or PF 805) may send a query message 1307 to CP 1326 (e.g., MM or XC) requesting instructions for the next-step action. In some aspects, the query message 1307 may include a previous TTL (e.g., TTL=TTL1=0), a previous BIFT-id (e.g., BIFT-id=BIFT-id1), and a previous source node BFIR-id (e.g., BFIR-id=PF 1320 or PF 801 in reference to FIG. 8A).

In some aspects, the received packet header may indicate the one or more leaf nodes that need to send the query message to CP. For example, in some aspects, the received packet header may indicate the one or more leaf nodes that need to send the query message to CP via the QI which indicates the one or more leaf nodes which need to send the query message to CP (e.g., QI may be a bitmap indicating the one or more leaf nodes which need to a send query message to CP).

In some aspects, the received packet header may indicate the one or more leaf nodes that need to send the query message to CP via the QI and one or more BFIR-ids. In such aspects, the QI may be a Boolean value=1, and the one or more BFIR-ids may identify the one or more leaf nodes which need to activate as a new source node and send query message 1307 to the CP for the next-step instruction when the TTL (e.g., TTL=0) indicates a completion of the packet's last hop of the first data path.

In some aspects, the received packet header may include a BitString that identifies a leaf node and further includes a TTL=0. The leaf node may check whether the packet header further includes a BFIR-id or a bitmap or an indicator identifying the leaf node for sending a query message to CP.

If the leaf node (e.g., PF 806 in reference to FIG. 8A) determines that packet header does not identify the leaf node (e.g., no BFIR-id exists that identifies the leaf node, or the bitmap does not identify the leaf node), then the leaf network node (e.g., PF 806) may execute the data processing as per the function list indicated in the packet header, and the procedure 1300 may then come to completion (the leaf node may stop the procedure).

If the leaf node determines that the packet header identifies the leaf node (e.g., a BFIR-id exists identifying the leaf node, or the bitmap identifies the leaf node), then the leaf network node (e.g., PF 1325 or PF 805) may send a query message 1307 (e.g., next step query message) to CP (e.g., MM or XC) to request instructions for the next-step action. The message 1307 may include one or more of: a previous TTL (e.g., TTL1=0), a previous BIFT-id (e.g., BIFT-id1), a previous source node BFIR-id (BFIR-id1).

In some aspects, procedure 1300 may further include CP 1326 performing one or more actions in response to the query message.

In some aspects, operations at CP may be based on the received packet header identifying the leaf node for sending the query message. For example, in some aspects, the received packet header may not identify the leaf node, e.g., the QI being a Boolean value=1. In such aspects, after receiving the query message, CP may send to each of the leaf nodes sending a query message a response based on whether the leaf node needs to switch to a source node. For example, in response to a query message sent from a leaf node that does not need to switch to a source node (e.g., PF 806), CP 1326 may send to such leaf node (e.g., PF 806) a query response message (e.g., next step response message) including a stop indication to instruct the leaf node to stop data forwarding.

In some aspects, in response to a query message sent form a leaf node that needs to switch to or activate as a new source node (e.g., PF 805), CP 1326 may send to such leaf node (e.g., PF 805) a query response message (e.g., next step response message) 1308. The query response message 1308 may include one or more of: a BIFT-id, a TTL, a BSL, a BitString, a BFIR-id, a switch instruction information, and a Function List.

In some aspects, some information in the query response message 1308, e.g., the BIFT-id, TTL, BSL, BitString, BFIR-id, switch instruction information, and Function List, may be similar to the corresponding information in the second packet header configuration information 1103 of FIG. 11.

In some aspects, the received packet header may identify the one or more leaf nodes that need to send a query message to CP, as described herein. For example, the received packet header may include a QI that identifies the one or more leaf nodes that need to send a query message to CP (e.g., QI being a bitmap indicating the one or more leaf nodes that need to send the query message to CP). In some aspects, the received packet header may include both a QI (e.g., being a Boolean value=1) and a BFIR-id (identifying the leaf node which need to switch to or activate as a new source node and send the query message to CP for the next step instructions when TTL=0). In such aspects, CP 1326 may send to the one or more leaf nodes (that need to send the query message to CP) e.g., PF 1325 or PF 805) a query response message (e.g., next step response message) 1308 including the instructions for the next-step action. The query response message 1308 may include one or more of: a BIFT-id, a TTL, a BSL, a BitString, a BFIR-id, a switch instruction information, and a Function List.

In some aspects, some information in the query response message 1308, e.g., the BIFT-id, TTL, BSL, BitString, BFIR-id, switch instruction information, and Function List, may be similar to the corresponding information in the second packet header configuration information 1103 of FIG. 11.

In some aspects, after receiving the query response 1308 from CP 1326, procedure 1300 may further include, each of one or more leaf network nodes (e.g., PF 1325, and in reference to FIG. 8A and 8B, PF 806 and PF 805) performing 1309 one or more operations.

In some aspects, if the response message 1308 indicates that the leaf node should stop the procedure (e.g., in the case that leaf node is not a source node for the next data forwarding path, for example, PF 806), the leaf node (e.g., PF 806), may execute the data processing as per the function list indicated in the packet header, and the procedure 1300 may then come to completion (the leaf node may stop the procedure).

In some aspects, if the response message 1308 indicates that the leaf node (e.g., PF 1325 or PF 805) should switch from a leaf node to a source node, then the leaf network node (e.g., PF 1325 or PF 805) may execute the data processing as per the function list, and further activate as a new source node (i.e., switch from a leaf node to a source node) starting to perform data forwarding based on a new BIFT identified by the next BIFT-id according to the data forwarding sequence.

In some aspects, the leaf node, active as source node (e.g., PF 1325 or PF 805) may remove, from the packet header, information associated with the previous data forwarding path (associated with the BIFT1) including one or more of: expired TTL (e.g., TTL1) and the corresponding BIFT-id (e.g., BIFT-id1), BLS (e.g., BLS1), BFIR-id (BFIR-id1) and BitString (e.g., BitString1).

In some aspects, the leaf network node (active as a new source node) may further perform bitwise AND (&) operation between the new BitString (e.g., BitString2=0011) and the FBM of each neighbor in the BIFT identified by the new BIFT-id (e.g., BIFT-id2). If the result is not 0, the current node (e.g., PF 1325 or PF 805) may encapsulate the bitwise AND result into the corresponding “BitString” field of the packet header and later sends the packet to the corresponding neighbor(s).

For example, in reference to FIG. 8B, operations at node PF 805 may include resetting the BitString towards PF 807 to 0011&0011=0011. Operations at node PF 805 may further include resetting the corresponding TTL: TTL2=TTL2−1=3, and further encapsulating the TTL: TTL2 into the packet header. Operations at node PF 805 may further include encapsulating the BFIR-id2 identifying PF 805 into packet header. Operations at node PF 805 may further include encapsulating BFR-id identifying the next-hop node (e.g., PF 807) into the packet header.

In some aspects, the leaf network node (active as the new source node) (e.g., PF 1325 or PF 805) may execute the data processing task indicated by the configured corresponding function (e.g., the function list in the query response 1308). The leaf node may then remove the used information (e.g., the one or more functions performed by the leaf node (active as the new source node) to process data) and encapsulate the remaining information of function list (e.g., the one or more functions yet to be performed) into packet header. In some aspects, the leaf node active as a source node may encapsulate the data processing result as packet payload into the packet.

In some aspects, the procedure 1300 may further include the leaf network node (active as a new source node) (e.g., PF 1125 or PF 805) sending the packet 1310 including the packet header and packet payload to the corresponding neighbor (i.e., PF 1322 or PF 807).

In some aspects, the procedure 1300 may further include, each of the intermediate nodes (e.g., in reference to FIG. 8B, PF 807 and PF 808), leaf node (PF 809, PF 810), or a new source node performing data forwarding and data processing based on the information included in the packet header according to corresponding operations described herein, until all TTLs turn to 0. Thereafter, the procedure 1300 may come to completion.

According to some aspects, an improved packet headers (e.g., packet header 900) may be provided that may allow for one or both of per-flow and per-tunnel traffic steering and data processing (e.g., for loop transmissions). As described herein, improved packet header 900 include fields indicating one or more of: BIFT-id List, TTL List, BSL list, BFIR-id List (identifying source nodes), BitString List, and Function List. One or more information in the packet header may be arranged in a data forwarding sequence. For example, BIFT-id List may be arranged in a data forwarding sequence of a mission. One or more other information (e.g., TTL List, BSL list, BitString List) may be arranged in the same order, e.g., according to the data forwarding sequence, in the packet header.

According to some aspects, e.g., in reference to FIGS. 10, 11, and 13, CP may configure packet header information to the data plane. Based on the configuration information, source node, intermediate nodes and leaf nodes may forward and process data as described herein.

According to some aspects, e.g., in reference to FIGS. 10, 11, and 13, leaf nodes may be activated as new source nodes and perform operations including one or more of: remove expired fields of packet header (e.g., previous BITF-id, TTL, BSL, BitString, Function and BFIR-id) when a previous TTL (e.g., TTL=0) indicates a completion of the packet's last hop of the previous data path, check whether the leaf node is a new data source, and perform data forwarding and data processing with new fields.

According to some aspects, an improved BIER-based scheme may be provided that involves the control plane to perform one or both of per-flow per-tunnel traffic steering and data processing, e.g., for loop transmission.

According to some aspects, and improved packet header, e.g., packet header 1200, may be provided. The packet header 1200 may include information indicating one or more of: a query indication, a BFIR-id (identifying a leaf node that needs to switch to a new source node).

According to some aspects, e.g., FIG. 11 and FIG. 12, CP may configure switch instructions to one or more leaf nodes. According to some aspects, source nodes and intermediate nodes may operate to forward and process data to receive switch instructions at one or more leaf nodes and further forward and process data based on further instructions as described herein.

According to some aspects, a leaf node (which is not to be active as a new source node) may send a next step query message to CP and receive, from CP, instruction to stop forwarding and processing data. According to some aspects, a leaf node to be active as a new source node, may, when a previous TTL (e.g., TTL=0) indicates a completion of the packet's last hop of the first data path, send a next step query message to CP and receive switch instruction information from CP. The leaf node (which need to be active as new source node) may further perform one or more of: remove expired fields of packet header and continue perform data forwarding and data processing.

One or more aspects may enable lower-overhead and flexible per-flow or per-tunnel traffic steering, e.g., for loop transmission. Some aspects may enable the underlay tunnel of data plane to be reusable or shareable by multiple data flows. According to some aspects, scalability in terms of data processing configuration may be improved. One or more aspects may be available and provide improvement to various cases (unicast, multicast, loop-free, non-loop-free).

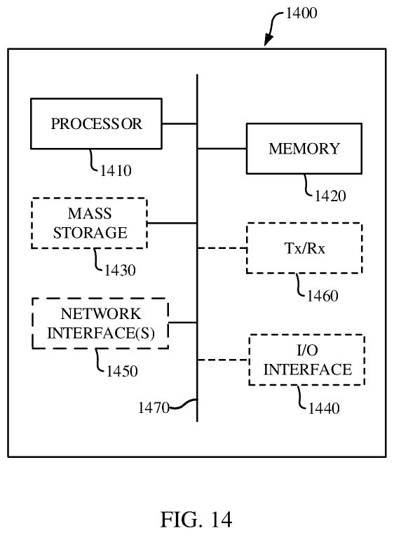

FIG. 14 illustrates an apparatus 1400 that may perform any or all of operations of the above methods and features explicitly or implicitly described herein, according to different aspects of the present disclosure. For example, a computer equipped with network function may be configured as the apparatus 1400. In some aspects, the apparatus 1400 may be a network function, a network node, a device, a processing function or an entity described herein which may be configured to perform one or more operations described herein. For example, apparatus 1400 may be any one of: a source node, an intermediate node, a leaf node, a control plane function as described in one or more aspects herein. In some aspect, apparatus 1400 can be a device that connects to the network infrastructure over a radio interface, such as a mobile phone, smart phone or other such device that may be classified as user equipment (UE). In some aspects, the apparatus 1400 may be a Machine Type Communications (MTC) device (also referred to as a machine-to-machine (m2m) device), or another such device that may be categorized as a UE despite not providing a direct service to a user. In some aspects, apparatus 1400 may be used to implement one or more aspects described herein. For example, the apparatus 1400 may be configured to perform operations performed by one or more entities and functions described herein.

As shown, the apparatus 1400 may include a processor 1410, such as a Central Processing Unit (CPU) or specialized processors such as a Graphics Processing Unit (GPU) or other such processor unit, memory 1420, non-transitory mass storage 1430, input-output interface 1440, network interface 1450, and a transceiver 1460, all of which are communicatively coupled via bi-directional bus 1470. According to certain aspects, any or all of the depicted elements may be utilized, or only a subset of the elements. Further, apparatus 1400 may contain multiple instances of certain elements, such as multiple processors, memories, or transceivers. Also, elements of the hardware device may be directly coupled to other elements without the bi-directional bus. Additionally, or alternatively to a processor and memory, other electronics, such as integrated circuits, may be employed for performing the required logical operations.

The memory 1420 may include any type of non-transitory memory such as static random-access memory (SRAM), dynamic random-access memory (DRAM), synchronous DRAM (SDRAM), read-only memory (ROM), any combination of such, or the like. The mass storage element 1430 may include any type of non-transitory storage device, such as a solid-state drive, hard disk drive, a magnetic disk drive, an optical disk drive, USB drive, or any computer program product configured to store data and machine executable program code. According to certain aspects, the memory 1420 or mass storage 1430 may have recorded thereon statements and instructions executable by the processor 1410 for performing any of the aforementioned method operations described above.

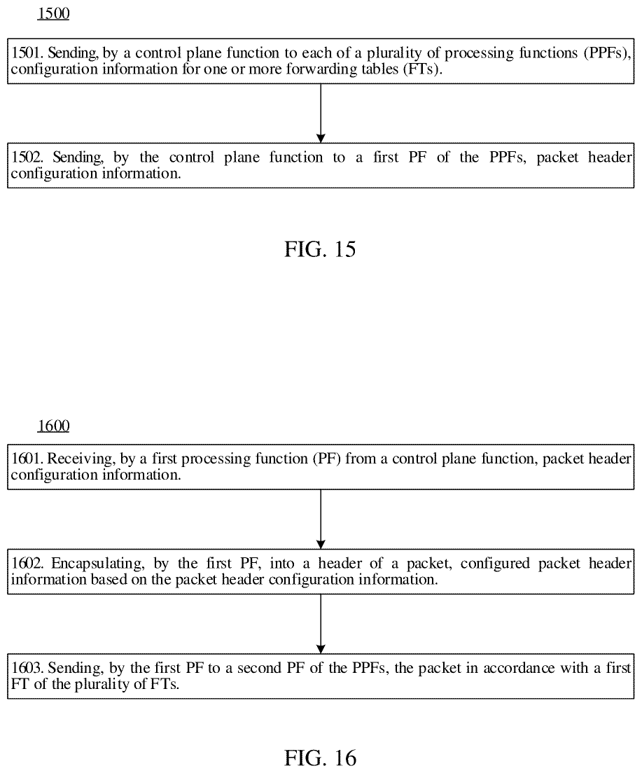

FIG. 15 illustrates a method for data forwarding and data processing by a control plane function, according to an aspect. The method 1500 may be performed by a control plane function, e.g., CP 1026 and may relate to operations performed by CP 1026 in reference to procedure 1000.

In an aspect, method 1500 include sending 1501, by the control plane function to each of a plurality of processing functions (PPFs), configuration information for one or more forwarding tables (FTs). Each of the one or more FTs may have a FT identifier (ID), and the PPFs may define a directed graph having a plurality of vertices and a plurality of directed edges. Each vertex of the plurality of vertices may correspond to a respective PF of the PPFs, and each directed edge of the plurality of directed edges may correspond to a hop of a path to be followed by processing data between a respective pair of PFs of the PPFs. The directed graph and the PPFs may be associated with a network service provided by a communication network. The configuration information for each forwarding table may include path information defining at least one path to be followed by the processing data between the PF at which the configuration data is received and another one or more PFs of the PPFs.

The method 1500 may further include sending 1502, by the control plane function to a first PF of the PPFs, packet header configuration information. The packet header configuration information may include a plurality of FTIDs defining a sequence of the paths to be followed by the processing data when the communication network provides the network service. Each FTID of the plurality of FTIDs may be associated with a respective one of the one or more FTs.

The path information may include neighbor PF data defining one or more next-hop PFs for the PF at which the configuration data is received. The path information may further include forwarding bit mask (FBM) data associated with each neighbor node indicating a set of leaf nodes of the PPFs to be reached by the processing data via said each neighbor node, The set of leaf nodes may be associated with the path corresponding to said each forwarding table.

The packet header configuration information may further include a plurality of time to live values (TTLVs) corresponding to the plurality of forwarding table IDs. Each TTLV of the plurality of TTLVs may correspond to a respective FTID of the plurality of FTIDs and indicate a number of hops remaining for the packet to reach a destination of the path. The packet header configuration information may further include a plurality of source node IDs corresponding to the plurality of forwarding table IDs. Each source node ID may correspond to a forwarding table ID and its associated data path. Each source node ID may further indicate a source node for initiating the associated data path.

The packet header configuration information may further include a plurality of bitstrings, each bitstring corresponding to a forwarding table ID and indicating one or more leaf PFs of a data path associated with the corresponding forwarding table ID. The packet header configuration information may further include a plurality of bitstring lengths (BSLs) corresponding to the plurality of bitstrings. Each BSL may define a length of a respective bitstring of the plurality of bitstrings and each BSL may correspond to a respective FTID.

The packer header configuration information may further include one or more functions IDs identifying one or more functions to be performed by one or more PFs of the plurality of PFs. The method may further include assigning, by the control plane function, to each PF that is a leaf PF of a data path, a bitstring indicating said each PF is the leaf PF.

FIG. 16 illustrates a method for data forwarding and data processing by a source node, according to an aspect. The method 1600 may be performed by a source node, e.g., PF 1020, and may relate to operations performed by PF 1020 in reference to procedure 1000.

The method 1600 includes receiving 1601, by a first PF from a control plane function, packet header configuration information. The first PF may be one of a plurality of processing functions (PPFs), where the PPFs define a directed graph having a plurality of vertices and a plurality of directed edges. Each vertex of the plurality of vertices may correspond to a respective PF of the PPFs, and each directed edge of the plurality of edges may correspond to a hop of a path to be followed by processing data between a respective pair of PFs of the PPFs. The directed graph and the PPFs may be associated with a network service provided by a communication network.

The packet header configuration information may include a plurality of forwarding table identifiers (FTIDs) associated with a respective plurality of forwarding tables (FTs). Each FT of the plurality of FTs may define a path to be followed by the processing data when the communication network provides the network service. The plurality of FTs may define a sequence of paths to be followed by the processing data.

The method 1600 may further include encapsulating 1602, by the first PF, into a header of a packet, configured packet header information based on the packet header configuration information. The method 1600 may further include sending 1603, by the first PF to a second PF of the PPFs, the packet in accordance with a first FT of the plurality of FTs.

The packet header configuration information may further include a plurality of time to live values (TTLVs) corresponding to the plurality of FTIDs. Each TTLV of the plurality of TTLVs may correspond to a respective FTID of the plurality of FTIDs and indicate a number of hops remaining for the packet to reach a destination of the path. The packet header configuration information may further include a plurality of source node IDs corresponding to the plurality of forwarding table IDs. Each source node ID may identify a PF of the PPFs and correspond to a respective FTID and its associated data path. Each source node ID may further indicate a source node for initiating the associated data path.

The packet header configuration information may further include a plurality of bitstrings corresponding to the plurality of FTIDs. Each bitstring may correspond to a respective FTID and indicate one or more leaf PFs of a data path associated with the corresponding FTID. The packet header configuration information may further include a plurality of bitstring lengths (BSLs) corresponding to the plurality of bitstrings. Each BSL may define a length of a respective bitstring of the plurality of bitstrings and each BSL may correspond to a respective FTID.

The method may further include receiving, by the first PF from the control plane function, configuration information for one or more FTs of the plurality of FTs including the first FT. The configuration information for each of the one or more FTs may include neighbor PF data defining one or more next-hop PFs for the PF at which the configuration data is received. The configuration information for each of the one or more FTs may further include forwarding bit mask (FBM) data associated with each neighbor node indicating a set of leaf nodes of the PPFs to be reached by the processing data via said each neighbor node. The set of leaf nodes associated with the path may correspond to said each of the one or more FTs.

The second PF may be a neighbor PF indicated by the configuration data of the first FT. The configured packet header information may include a result of a bitwise AND (&) operation. The result of a bitwise AND (&) operation may be based on a first bitstring of the plurality of bitstrings corresponding to the first forwarding table. The result of a bitwise AND (&) operation may further be based FBM data of the first forwarding table and associated with the neighbor node. The result of a bitwise AND (&) operation may further be based an updated TTLV corresponding to the first FT. The result of a bitwise AND (&) operation may further be based the plurality of source node IDs.

The packet header configuration information may further indicate a first set of functions IDs identifying a first set of functions to be performed by one or more PFs of the PPFs including the first PF. The first set of function IDs may be arranged according to the sequence of paths to be followed by the processing data. The method may further include processing, by the first PF, the processing data according to one or more functions of the first set of functions to obtain results, the one or more functions being associated with the first PF and with a first FT.

The configured packet header information may further include a second set of function IDs identifying a second set of functions to be performed by the one or more PFs of the PPFs. The second set of functions may include the first set of functions and exclude the one or more functions being associated with the first PF and with the first FT.

The method may further include encapsulating, by the first PF into a payload of the packet, the results. Sending, by the first PF to the second PF, the packet based on a first forwarding FT indicated by the sequence of paths may include sending the packet including the payload.

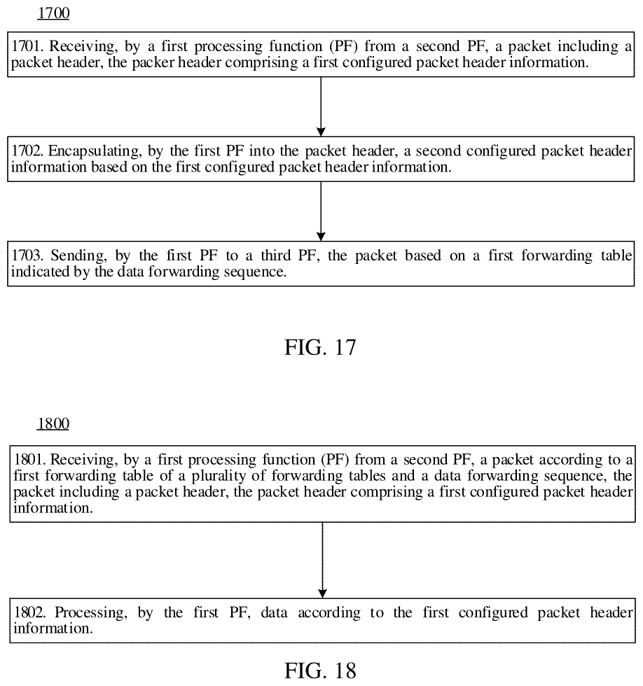

FIG. 17 illustrates a procedure for data forwarding and data processing by an intermediate node, according to an aspect. The method 1700 may be performed by an intermediate function, e.g., PF 1022, and may relate to operations performed by PF 1022 in reference to procedure 1000.

According to an aspect, the method 1700 incudes receiving 1701, by a PF from a second PF, a packet including a packet header, the packer header including a first configured packet header information. The first configured packet header information may include a plurality of forwarding table identifiers (IDs) corresponding to and indicating a data forwarding sequence of a plurality of data paths of a mission associated with one or more services. The plurality of forwarding table IDs identifies a plurality of forwarding tables, where each forwarding table corresponds to a data path of the plurality of data paths. Each data path may be based on a directed graph of the mission. In some aspects, the second PF here can be the firstly involved PF or another intermediated node.

The method 1700 may further include encapsulating 1702, by the first PF into the packet header, a second configured packet header information based on the first configured packet header information.

The method 1700 may further include sending 1703, by the first PF to a third PF, the packet based on a first forwarding table indicated by the data forwarding sequence. In some aspects, the third PF (e.g., a third intermediate node, or a leaf node) may be a next-hop node of the first PF (i.e., the intermediate node).

The first configured packet header information may further indicate a plurality of time to live values (TTLVs) corresponding to the plurality of forwarding table IDs. Each TTLV may correspond to a forwarding table ID and indicate a number of hops remaining for the packet to reach a destination of the path. The first configured packet header information may further indicate a plurality of source node IDs corresponding to the plurality of forwarding table IDs. Each source node ID may correspond to a forwarding table ID and its associated data path. Each source node ID may further indicate a source node for initiating the associated data path.

The first configured packet header information may further indicate a plurality of bitstrings corresponding to the plurality of forwarding table IDs. Each bitstring may correspond to a forwarding table ID and indicate one or more leaf nodes of a data path associated with the corresponding forwarding table ID. The first configured packet header information may further indicate a plurality of bitstring lengths (BSLs) corresponding to the plurality of bitstrings. Each BSL may define a length of a respective bitstring of the plurality of bitstrings and each BSL may correspond to a respective FTID.

In some aspects, the method may further include receiving, by the first PF from a control plane function, configuration information for one or more forwarding tables of the plurality of forwarding tables including the first forwarding table. The configuration information for each of the one or more forwarding tables may include one or more neighbor nodes for a next hop. The configuration information for each of the one or more forwarding tables may further include forwarding bit mask (FBM) information associated with each neighbor node indicating a set of leaf nodes that can be reached via said each neighbor node, the set of leaf nodes associated with a data path corresponding to said each forwarding table.

The third PF may be a neighbor node indicated by the configuration information of the first forwarding table. The second configured header information may include a result of a bitwise AND (&) operation. The result of a bitwise AND (&) operation may be based on a first bitstring of the plurality of bitstrings corresponding to the first forwarding table. The result of a bitwise AND (&) operation may be further based on an FBM information of the first forwarding table and associated with the neighbor node.

The second configured header information may further include an updated TTL value corresponding to the first forwarding table. The second configured header information may further include the plurality of source node IDs.

The first packet header configuration information may further indicate a first set of functions IDs identifying a first set of functions to be performed by one or more PFs of a plurality of PFs including the first PF. The first set of function IDs may be arranged according to the data forwarding sequence. The method may further include processing, by the first PF, data according to one or more functions of the first set of functions to obtain results, the one or more functions associated with the first PF and a first forwarding table.

The second configured packet header information may further include a second set of function IDs identifying a second set of functions to be performed by the one or more PFs. The second set of functions may include the first set of functions and exclude the one or more functions associated with the first PF and a first forwarding table.

In some aspects, the method may further include encapsulating, by the first PF into a payload of the packet, the results. Sending, by the first PF to a third PF, the packet based on a first forwarding table indicated by the data forwarding sequence may include sending the packet including the payload.

FIG. 18 illustrates a procedure for data forwarding and data processing by a leaf node, according to an aspect. The method 1800 may be performed by, e.g., PF 1025, and may relate to operations performed by PF 1022 in reference to procedure 1000.

According to an aspect, method 1800 may include receiving 1801, by a first processing function (PF) from a second PF, a packet according to a first forwarding table of a plurality of forwarding tables and a data forwarding sequence. The packet may include a packet header, the packet header further including a first configured packet header information. The first configured packet header information may include a plurality of forwarding table identifiers (IDs) corresponding to and indicating the data forwarding sequence of a plurality of data paths of a mission associated with one or more services. The plurality of forwarding table IDs identifying the plurality of forwarding tables including the first forwarding table. Each forwarding table corresponding to a data path of the plurality of data paths, and each data path being based on a directed graph of the mission.

The method 1800 may further include processing 1802, by the first PF, data according to the first configured packet header information.

The first configured packet header information may further indicate a plurality of time to live (TTL) values corresponding to the plurality of forwarding table IDs. Each TTL value may correspond to a forwarding table ID and indicate a number of hops remaining for the packet to reach a destination of the path. The first configured packet header information may further indicate a first TTL value of the plurality of TTL values corresponding to the first forwarding table indicating that the packet has completed its last hop according to a data path corresponding to the first forwarding table.

The first configured packet header information may further indicate a plurality of bitstrings corresponding to the plurality of forwarding table IDs. Each bitstring may correspond to a forwarding table ID and indicate one or more leaf nodes of a data path associated with the corresponding forwarding table ID. The first configured packet header information may further indicate a first bitstring of the plurality of bitstrings corresponding to the first forwarding table indicating the first PF as a leaf node of the data path corresponding to the first forwarding table.

The first configured packet header information may further indicate a plurality of source node IDs corresponding to the plurality of forwarding table IDs. Each source node ID may correspond to a forwarding table ID and its associated data path, and indicate a source node for initiating the associated data path. The first configured packet header information may further indicate a first source node ID of the plurality of source node IDs corresponding to the first forwarding table.

The first configured packet header information may further indicate a second source node ID of the plurality of source node IDs corresponding to a second forwarding table of the plurality of forwarding tables. The second forwarding table may be a next forwarding table after the first forwarding table according to the data forwarding sequence. The second source node ID may identify the first PF as a source node of a second data path associated with second forwarding table.

The first configured packet header information may further indicate a first set of functions IDs identifying a first set of functions to be performed by one or more PFs of a plurality of PFs including the first PF, the first set of function IDs arranged according to the data forwarding sequence. In some aspects, processing, by the first PF, data according to the first configured packet header information may include processing, by the first PF, the data according to one or more functions of the first set of functions to obtain a first result, the one or more functions associated with the first PF and a first forwarding table.

In some aspects, the method may further include encapsulating, by the first PF into the packet of the packet, a second configured packet header information based on the first configured packet header information. The method may further include sending, by the first PF to a third PF, the packet according to the second data path associated with the second forwarding table.

In some aspects, the method may further include receiving, by the first PF from the control plane function, configuration information for one or more forwarding tables of the plurality of forwarding tables including the second forwarding table. The configuration information for each of the one or more forwarding tables may include one or more neighbor nodes for a next hop. The configuration information for each of the one or more forwarding tables may further include forwarding bit mask (FBM) information associated with each neighbor node indicating a set of leaf nodes that can be reached via said each neighbor node, the set of leaf nodes associated with a data path corresponding to said each forwarding table.

The third PF may be a neighbor node indicated by the configuration information of the second forwarding table. The second configured packet header information may include a result of a bitwise AND (&) operation. The result of a bitwise AND (&) operation may be based on a second bitstring of the plurality of bitstrings corresponding to the second forwarding table. The result of a bitwise AND (&) operation may further be based on an FBM information of the second forwarding table and associated with the neighbor node. The second configured packet header information may further include a updated TTL value corresponding to the second forwarding table. The second configured packet header information may further include the second source node ID. The second configured packet header information may exclude one or more of: the first TTL value, the first bitstring, the first source ID.

In some aspects, the method 1800 may further include further processing, by the first PF, the data according to one or more functions of the first set of functions to obtain a second result, the one or more functions associated with the first PF and the second forwarding table. The second configured packet header information may include a second set of function IDs identifying a second set of functions to be performed by one or more PFs. The second set of functions may include the first set of functions and exclude the one or more functions associated with the first PF and the first forwarding table. The second set of function may further exclude the one or more functions associated with the first PF and the second forwarding table.

In some aspects, the method 1800 may further include encapsulating, by the first PF into a payload of the packet, one or more of: the first result and the second result. In some aspects, sending, by the first PF to the third PF, the packet according to the second data path associated with the second forwarding table may include sending the packet including the payload.

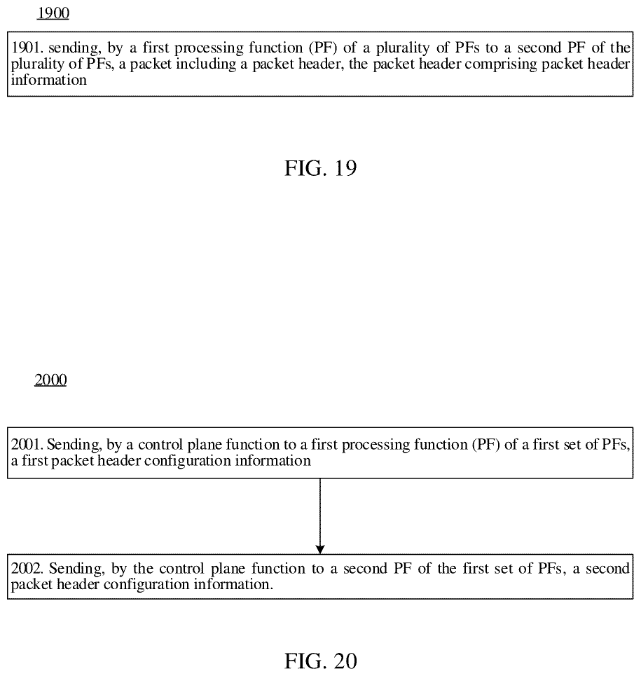

FIG. 19 illustrates a method for transmitting an enhanced packet in executing a mission, according to an aspect. The method 1900 may be performed by a PF of a plurality of PFs involved in a mission. For example, the method 1900 may be performed any one of a source node, e.g., PF 1020, an intermediate node, e.g., PF 1022, and a leaf node, e.g., PF 1025. The method may relate to operations performed in reference to procedure 1000.

According to an aspect, the method 1900 include sending 1901, by a first processing function (PF) of a plurality of PFs to a second PF of the plurality of PFs, a packet including a packet header, where the packet header includes packet header information. The packet header information may indicate a plurality of forwarding table identifiers (IDs) corresponding to and indicating a data forwarding sequence of a plurality of data paths of a mission associated with one or more services. The plurality of forwarding table IDs may identify a plurality of forwarding tables, where each forwarding table may correspond to a data path of the plurality of data paths, and each data path may be based on a directed graph of the mission.

The packet header information may further indicate a plurality of time to live (TTL) values corresponding to the plurality of forwarding table IDs. Each TTL value may correspond to a forwarding table ID and indicate a number of hops remaining for the packet to reach a destination of the path. The packet header information may further indicate a plurality of source node IDs corresponding to the plurality of forwarding table IDs. Each source node ID may correspond to a forwarding table ID and its associated data path. Each source node ID may further indicate a source node for initiating the associated data path.

The packet header information may further indicate a plurality of bitstrings corresponding to the plurality of forwarding table IDs. Each bitstring may correspond to a forwarding table ID and indicate one or more leaf nodes of a data path associated with the corresponding forwarding table ID. The packet header information may further indicate a plurality of bitstring lengths (BSLs) corresponding to the plurality of bitstrings. Each BSL may define a length of a respective bitstring of the plurality of bitstrings and each BSL corresponding to a forwarding table ID.

The packet header information may further indicate a first set of functions IDs identifying a first set of functions to be performed by one or more PFs of the plurality of PFs, the first set of function IDs arranged according to the data forwarding sequence.

FIG. 20 illustrates another method for data forwarding and data processing by a control plane function, according to an aspect. The method 2000 may be performed by a control plane function, e.g., CP 1126 or 1326. The method 2000 may further relate to one or more operations performed by CP 1126 in reference to procedure 1100 and CP 1326 in reference to procedure 1300.

According to an aspect, the method 2000 include sending 2001, by a control plane function to a first processing function (PF) of a first set of PFs, a first packet header configuration information. The first packet header configuration information may indicate a first set of functions to be performed by one or more PFs of the first set of PFs. The first packet header configuration information may further indicate a first forwarding table identifier (ID) identifying a first forwarding table for a first data path.

The method 2000 may further include sending 2002, by the control plane function to a second PF of the first set of PFs, a second packet header configuration information. The second packet header configuration information may indicate a second set of functions to be performed by one or more PFs of a second set of PFs. The second packet header configuration information may further indicate a second forwarding table identifier (ID) identifying a second forwarding table for a second data path.

The second packet header configuration information may further indicate a switch instruction indicating the second PF to initiate the second data path. The indication to initiate the second data path may be based on receiving an indicator in a received packet, the indicator indicating a completion of the packet's last hop of the first data path.

The switch instruction may include a first source node ID identifying a source node for initiating the first data path according to the first forwarding table. The switch instruction may further include the first forwarding table ID identifying the first forwarding table. The indication to initiate the second data path may be based on receiving a packet having a packet header. The packet header may include an indicator indicating a completion of the packet's last hop of the first data path. The packet header may further include the first source node ID. The packet header may further include the first forwarding table ID.

The first packet header configuration information may further include a query indication. The query indication may indicate that a leaf node of the first data path should send a query message to the control plane function requesting for further instructions when the leaf node receives a packet including a packet header indicating one or more of the following. The packet header may indicate an indicator indicating a completion of a packet's last hop of the first data path. The packet header may further indicate a source node ID identifying the leaf node as a second source node for initiating the second data path.

In some aspects, where the second PF is the leaf node of the first data path, the method may further include receiving, by the control plane function from the second PF, the query message. The second packet header confirmation information may be in response to the query message.

In some aspects, the method may further include sending, by the control plane function to each of the first set of PFs, configuration information for one or more forwarding tables. Each forwarding table may be associated with an identifier (ID). The configuration information for each forwarding table may indicate information for forwarding data according to a data path based on a directed graph of a mission associated with one or more services. The information for forwarding data may include one or more neighbor nodes for a next-hop from said each PF. The information for forwarding data may further include forwarding bit mask (FBM) information indicating a set of leaf nodes associated with the data path that can be reached via said each neighbor node.

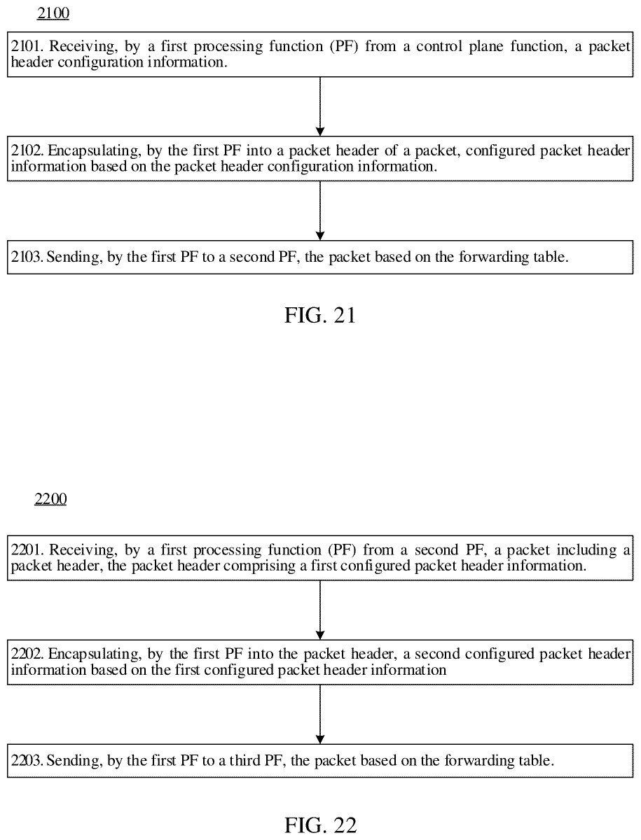

FIG. 21 illustrates another method for data forwarding and data processing by a source node, according to an aspect. The method 2100 may be performed by a source node, e.g., PF 1120 or 1320. The method 2100 may further relate to one or more operations performed by PF 1120 in reference to procedure 1100 and PF 1320 in reference to procedure 1300.

According to an aspect, the method 2100 includes receiving 2101, by a first processing function (PF) from a control plane function, a packet header configuration information. The packet header configuration information may indicate a set of functions to be performed by one or more PFs. The packet header configuration information may further indicate a forwarding table identifier (ID) identifying a forwarding table for a data path.

The method 2100 may further include encapsulating 2102, by the first PF into a packet header of a packet, configured packet header information based on the packet header configuration information. The method 2100 may further include sending 2103, by the first PF to a second PF, the packet based on the forwarding table.

The packet header configuration information may further indicate a time to live (TTL) value corresponding to the data path, the TTL value indicating a number of hops remaining for the packet to reach a destination of the data path. The packet header configuration information may further indicate a source node ID corresponding to the forwarding table, the source node ID identifying the first PF as a source node for initiating the data path. The packet header configuration information may further indicate a bitstring indicating one or more leaf node of the data path.

In some aspects, the method may further include receiving, by the first PF from the control plane function, configuration information for the forwarding table. The configuration information for the forwarding table may include one or more neighbor nodes for a next-hop. The configuration information for the forwarding table may further include forwarding bit mask (FBM) information associated with each neighbor node indicating a set of leaf nodes that can be reached via said each neighbor node, the set of leaf nodes associated with the data path.

The second PF may be a neighbor node indicated by the configuration information of the forwarding table. The configured packet header information may include a result of a bitwise AND (&) operation. The result of a bitwise AND (&) operation may be based on the bitstring. The result of a bitwise AND (&) operation may further be based on an FBM information of the forwarding table and associated with the neighbor node. The configured packet header information may further include an updated TTL value based on the TTL value. The configured packet header information may further include the source node ID.

The packet header configuration information may further indicate a query indication. The query indication may indicate that a leaf node of the data path should send a query message to the control plane function requesting for further instructions when the leaf node receives the packet. The packet includes the packet header which may indicate the TTL indicating a completion of the packet's last hop of the first data path. The packet header may further indicate a second source node ID identifying the leaf node as a second source node for initiating a second data path.

The packet header configuration information may further indicate the second source node ID. The configured packet header information may further indicate the query indication and the second source node ID.

In some aspects, the method may further include processing, by the first PF, data according to one or more functions of the set of functions to obtain results, the one or more functions associated with the first PF. The configured packet header information may further indicate a second set of function to be performed by the one or more PFs, the second set of functions including the first set of functions and excluding the one or more functions associated with the first PF.

In some aspects, the method may further include encapsulating, by the first PF into a payload of the packet, the results, wherein sending, by the first PF to the second PF, the packet based on the forwarding table includes sending the packet including the payload.

FIG. 22 illustrates another method for data forwarding and data processing by an intermediate node, according to an aspect. The method 2200 may be performed by an intermediate node, e.g., PF 1122 or 1322. The method 2200 may further relate to one or more operations performed by PF 1122 in reference to procedure 1100 and PF 1322 in reference to procedure 1300.

According to an aspect, the method 2200 includes receiving 2201, by a first processing function (PF) from a second PF, a packet including a packet header, the packet header including a first configured packet header information. The first configured packet header information may indicate a set of functions to be performed by one or more PFs. The first configured packet header information may further indicate a forwarding table identifier (ID) identifying a forwarding table for a data path.

The method 2200 may further include encapsulating 2202, by the first PF into the packet header, a second configured packet header information based on the first configured packet header information. The method 2200 may further include sending 2203, by the first PF to a third PF, the packet based on the forwarding table.

The first configured packet header information may further indicate a time to live (TTL) value corresponding to the data path, the TTL value indicating a number of hops remaining for the packet to perform to reach a destination of the data path. The first configured packet header information may further indicate a bitstring indicating one or more leaf node of the data path.

In some aspects, the method may further include receiving, by the first PF from a control plane function, configuration information for the forwarding table. The configuration information for the forwarding table may include one or more neighbor nodes for a next hop. The configuration information for the forwarding table may further include forwarding bit mask (FBM) information associated with each neighbor node indicating a set of leaf nodes that can be reached via said each neighbor node, the set of leaf nodes associated with the data path.

In some aspects, the second PF may be a neighbor node indicated by the configuration information of the forwarding table. The second configured packet header information may include a result of a bitwise AND (&) operation. The result of a bitwise AND (&) operation may be based on the bitstring. The result of a bitwise AND (&) operation may further be based on an FBM information of the forwarding table and associated with the neighbor node. The second configured packet header information may further include an updated TTL value based on the TTL value.

The first packet header configuration information may further indicate a query indication. The query indication may indicate that a leaf node of the data path should send a query message to a control plane function requesting for further instructions when the leaf node receives the packet including the packet header. The packet header may include the TTL indicating a completion of the packet's last hop of the data path. The packet header may further include a second source node ID identifying the leaf node as a second source node for initiating a second data path.

The first packet header configuration information may further indicate the second source node ID. The second packet header configuration information may further indicate the query indication, and the second source node ID.

In some aspects, the method may further include processing, by the first PF, data according to one or more functions of the set of functions to obtain results, the one or more functions associated with the first PF. In some aspects, the method may further include encapsulating, by the first PF into a payload of the packet, the results, wherein sending, by the first PF to the second PF, the packet based on the forwarding table includes sending the packet including the payload.

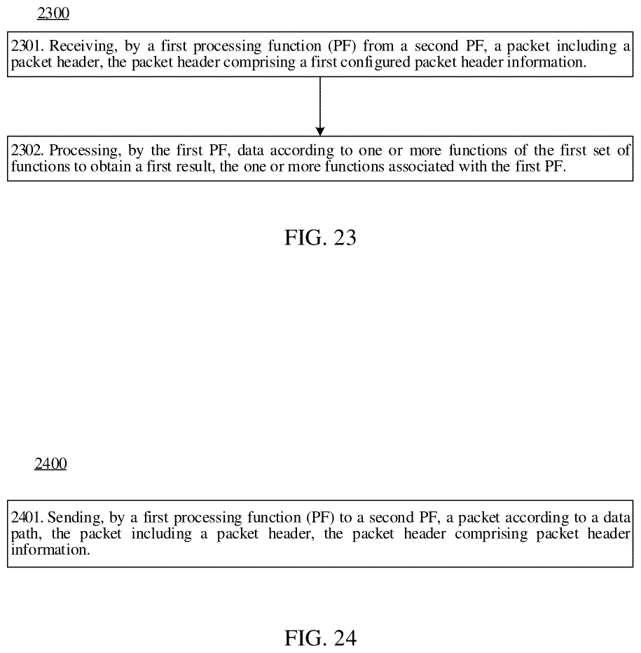

FIG. 23 illustrates another method for data forwarding and data processing by a leaf node, according to an aspect. The method 2300 may be performed by a leaf node, e.g., PF 1125 or 1325. The method 2300 may further relate to one or more operations performed by PF 1125 in reference to procedure 1100 and PF 1325 in reference to procedure 1300.

According to an aspect, the method 2300 includes receiving 2301, by a first processing function (PF) from a second PF, a packet including a packet header, the packet header including a first configured packet header information. The first configured packet header information may include a first set of functions to be performed by one or more PFs of a first set of PFs. The first configured packet header information may further include a first forwarding table identifier (ID) identifying a first forwarding table for a first data path.

The method 2300 may further include processing 2302, by the first PF, data according to one or more functions of the first set of functions to obtain a first result, the one or more functions associated with the first PF.

The first configured packet header information may further indicate a first indicator corresponding to the first data path and indicating a completion of the packet's last hop of the first data path. The first configured packet header information may further indicate a first source node ID identifying a first source node for initiating the first data path. The first configured packet header information may further indicate a bitstring indicating one or more leaf node of the first data path.

In some aspects, the method 2300 may further include receiving, by the first PF from a control plane function, a packet header configuration information. The packet header configuration information may include a second forwarding table identifier (ID) identifying a second forwarding table for a second data path. The packet header configuration information may further include a second bitstring indicating one or more leaf nodes of the second data path. The packet header configuration information may further include a second source node ID identifying a second source node for initiating the second data path. The packet header configuration information may further include a second indicator indicating a number of hops remaining for the packet to perform to reach a destination of the second data path.

The packet header configuration information further indicates a switch instruction. The switch instruction may indicate the first PF to initiate the second data path. The switch instruction indicating to initiate the second data path may be based on the first indicator indicating a completion of the packet's last hop of the first data path. The switch instruction indicating to initiate the second data path may further be based on the bitstring indicating the first PF as a leaf node of the first data path. The switch instruction indicating to initiate the second data path may further be based on the second source node ID identifying the first PF as the second source node for initiating the second data path.

The packet header configuration information may further include a query indication. The query indication may indicate that a leaf node of the first data path should send a query message to the control plane function requesting for further instructions when the leaf node receives the packet including the packet header. The packet header may include the first indicator indicating a completion of the packet's last hop of the first data path. The packet header may further include the bitstring indicating the first PF as a leaf node of the first data path. The packet header may further include the second source node ID identifying the first PF as the second source node for initiating the second data path.

In some aspects, the method 2300 may further include sending, by the first PF to the control plane function, the query message, wherein the packet header configuration information is a response to the query message.

In some aspects, the method 2300 may further include encapsulating, by the first PF into the packet header, a second configured packet header information based on the first configured packet header information and the packet header configuration information. In some aspects, the method 2300 may further include sending, by the first PF to a third PF, the packet according to the second data path.

In some aspects, the method 2300 may further include receiving, by the first PF from the control plane function, configuration information for the second forwarding table. The configuration information may include one or more neighbor node for a next-hop. The configuration information may further include forwarding bit mask (FBM) information associated with each neighbor node indicating a set of leaf nodes that can be reached via said each neighbor node, the set of leaf nodes associated with the second data path.

In some aspects, the third PF may be a neighbor node indicated by the configuration information of the second forwarding table. The second configured packet header information may include a result of a bitwise AND (&) operation. The result of the bitwise AND (&) operation may be based on the second bitstring. The result of the bitwise AND (&) operation may further be based on an FBM information of the second forwarding table and associated with the neighbor node. The second configured packet header information may further include an updated indicator based on the second indicator. The second configured packet header information may further include the second source node ID. The second configured packet header information may exclude one or more of: the first indicator, the first bitstring, and the first source ID.

The packet header configuration information may further indicate a second set of functions to be performed by one or more PFs of a second set of PFs, and the method may further include processing, by the first PF, the data according to one or more functions of the second set of functions to obtain a second result.

The second configured packet header information may further indicate a third set of functions including the second set of functions and excluding the one or more functions used to obtain the second result.

In some aspects, the method 2300 may further include encapsulating, by the first PF into a payload of the packet, one or more of: the first result and the second result. Sending, by the first PF to the third PF, the packet according to the second data path may include sending the packet including the payload.

FIG. 24 illustrates another method for transmitting an enhanced packet in executing a mission, according to an aspect. The method 2400 may be performed by a PF of a plurality of PFs involved in a mission. For example, the method 240000 may be performed any one of a source node, e.g., PF 1120 and 1320, an intermediate node, e.g., PF 1022 and 1322, and a leaf node, e.g., PF 1025 and 1325. The method may relate to one or more operations performed in reference to procedure 1100 and 1300.

According to an aspect, the method 2400 includes sending 2401, by a first processing function (PF) to a second PF, a packet according to a data path, the packet including a packet header, and the packet header including packet header information. The packet header information may include a set of functions to be performed by one or more PFs including the second PF. The packet header information may further include a forwarding table identifier (ID) identifying a forwarding table for the data path.

The packet header information may further include an indicator corresponding to the data path, the indicator indicating a number of hops remaining for the packet to perform to reach a destination of the data path. The packet header information may further include a source node ID identifying a source node for initiating the data path. The packet header information may further include a bitstring indicating one or more leaf node of the data path.

The packet header information may further include a query indication. The query indication may indicate that a leaf node of the data path should send a query message to a control plane function requesting for further instructions when the leaf node receives the packet including the packet header. The packet header may include the indicator indicating a completion of the packet's last hop of the data path. The packet header may further include a second source node ID identifying a second source node for initiating a second data path.

Aspects of the present disclosure can be implemented using electronics hardware, software, or a combination thereof. In some aspects, this may be is implemented by one or multiple computer processors executing program instructions stored in memory. In some aspects, the invention is implemented partially or fully in hardware, for example using one or more field programmable gate arrays (FPGAs) or application specific integrated circuits (ASICs) to rapidly perform processing operations.

It will be appreciated that, although specific aspects of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present invention. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding aspects, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disc read-only memory (CD-ROM), USB flash disk, or a removable hard disk. The software product includes a number of instructions that enable a computer device (personal computer, server, or network device) to execute the methods provided in the aspects of the present invention. For example, such an execution may correspond to a simulation of the logical operations as described herein. The software product may additionally or alternatively include a number of instructions that enable a computer device to execute operations for configuring or programming a digital logic apparatus in accordance with aspects of the present invention.

Although the present invention has been described with reference to specific features and aspects thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

What is claimed is:

1. A method comprising:
sending, by a control plane function to each of a plurality of processing functions (PPFs), configuration information for one or more forwarding tables (FTs), each of the one or more FTs having associated thereto a FT identifier (ID), the PPFs defining a directed graph having a plurality of vertices and a plurality of directed edges, each vertex of the plurality of vertices corresponding to a respective PF of the PPFs, each directed edge of the plurality of directed edges corresponding to a hop of a path to be followed by processing data between a respective pair of PFs of the PPFs, the directed graph and the PPFs being associated with a network service provided by a communication network, and the configuration information for each forwarding table including:
path information defining at least one path to be followed by the processing data between the PF at which the configuration information is received and another one or more PFs of the PPFs; and
sending, by the control plane function to a first PF of the PPFs, packet header configuration information including:
a plurality of FTIDs defining a sequence of the paths to be followed by the processing data when the communication network provides the network service, each FTID of the plurality of FTIDs being associated with a respective one of the one or more FTs.

2. The method of claim 1, wherein the path information comprises one or more of:
neighbor PF data defining one or more next-hop PFs for the PF at which the configuration information is received, or
forwarding bit mask (FBM) data associated with each neighbor node indicating a set of leaf nodes of the PPFs to be reached by the processing data via said each neighbor node, the set of leaf nodes associated with the path corresponding to said each forwarding table.

3. The method of claim 1, wherein the packet header configuration information further includes one or more of:
a plurality of time to live values (TTLVs) corresponding to the plurality of forwarding table IDs, each TTLV of the plurality of TTLVs corresponding to a respective FTID of the plurality of FTIDs and indicating a number of hops remaining for the packet to reach a destination of the path;
a plurality of source node IDs corresponding to the plurality of forwarding table IDs, each source node ID:
corresponding to a forwarding table ID and its associated data path; and
indicating a source node for initiating the associated data path;
a plurality of bitstrings, each bitstring corresponding to a forwarding table ID and indicating one or more leaf PFs of a data path associated with the corresponding forwarding table ID; or
a plurality of bitstring lengths (BSLs) corresponding to the plurality of bitstrings, each BSL defining a length of a respective bitstring of the plurality of bitstrings and each BSL corresponding to a respective FTID.

4. The method of claim 1, wherein the packer header configuration information further includes one or more functions IDs identifying one or more functions to be performed by one or more PFs of the plurality of PFs.

5. The method of claim 1 further comprising:
assigning, by the control plane function, to each PF that is a leaf PF of a data path, a bitstring indicating said each PF is the leaf PF.

6. A method comprising:
by a first processing function (PF) of a plurality of processing functions (PPFs), the PPFs defining a directed graph having a plurality of vertices and a plurality of directed edges, each vertex of the plurality of vertices corresponding to a respective PF of the PPFs, each directed edge of the plurality of edges corresponding to a hop of a path to be followed by processing data between a respective pair of PFs of the PPFs, the directed graph and the PPFs being associated with a network service provided by a communication network:
receiving, from a control plane function, packet header configuration information including:
a plurality of forwarding table identifiers (FTIDs) associated with a respective plurality of forwarding tables (FTs), each FT of the plurality of FTs defining a path to be followed by the processing data when the communication network provides the network service, the plurality of FTs defining a sequence of paths to be followed by the processing data;
encapsulating, by the first PF, into a header of a packet, configured packet header information based on the packet header configuration information; and
sending, by the first PF to a second PF of the PPFs, the packet in accordance with a first FT of the plurality of FTs.

7. The method of claim 6, wherein the packet header configuration information further includes one or more of:
a plurality of time to live values (TTLVs) corresponding to the plurality of FTIDs, each TTLV of the plurality of TTLVs corresponding to a respective FTID of the plurality of FTIDs and indicating a number of hops remaining for the packet to reach a destination of the path;
a plurality of source node IDs corresponding to the plurality of forwarding table IDs, each source node ID:
being a PF of the PPFs;
corresponding to a respective FTID and its associated data path; and
indicating a source node for initiating the associated data path;
a plurality of bitstrings corresponding to the plurality of FTIDs, each bitstring corresponding to a respective FTID and indicating one or more leaf PFs of a data path associated with the corresponding FTID; or
a plurality of bitstring lengths (BSLs) corresponding to the plurality of bitstrings, each BSL defining a length of a respective bitstring of the plurality of bitstrings and each BSL corresponding to a respective FTID.

8. The method of claim 6 further comprising:
receiving, by the first PF from the control plane function, configuration information for one or more FTs of the plurality of FTs including the first FT, wherein the configuration information for each of the one or more FTs comprises one or more of:
neighbor PF data defining one or more next-hop PFs for the PF at which the configuration information is received, or
forwarding bit mask (FBM) data associated with each neighbor node indicating a set of leaf nodes of the PPFs to be reached by the processing data via said each neighbor node, the set of leaf nodes associated with the path corresponding to said each of the one or more FTs.

9. The method of claim 8, wherein:
the second PF is a neighbor PF indicated by the configuration information of the first FT; and
the configured packet header information comprises one or more of:
a result of a bitwise AND (&) operation based on:
a first bitstring of a plurality of bitstrings corresponding to the first forwarding table, and
FBM data of the first forwarding table and associated with the neighbor node;
an updated TTLV corresponding to the first FT; or
a plurality of source node IDs.

10. The method of claim 9, wherein the packet header configuration information further indicates a first set of functions IDs identifying a first set of functions to be performed by one or more PFs of the PPFs including the first PF, the first set of function IDs arranged according to the sequence of paths to be followed by the processing data, and the method further comprising:
processing, by the first PF, the processing data according to one or more functions of the first set of functions to obtain results, the one or more functions being associated with the first PF and with a first FT.

11. The method of claim 10, wherein the configured packet header information further comprises:
a second set of function IDs identifying a second set of functions to be performed by the one or more PFs of the PPFs, the second set of functions comprising the first set of functions and excluding the one or more functions being associated with the first PF and with the first FT.

12. The method of claim 10 further comprising:
encapsulating, by the first PF into a payload of the packet, the results, wherein sending, by the first PF to the second PF, the packet based on a first forwarding FT indicated by the sequence of paths comprises sending the packet including the payload.

13. A method comprising:
receiving, by a first processing function (PF) from a second PF, a packet including a packet header, the packer header comprising first configured packet header information indicating:
a plurality of forwarding table identifiers (IDs) corresponding to and indicating a data forwarding sequence of a plurality of data paths of a mission associated with one or more services, the plurality of forwarding table IDs identifying a plurality of forwarding tables, each forwarding table corresponding to a data path of the plurality of data paths, each data path being based on a directed graph of the mission;
encapsulating, by the first PF into the packet header, a second configured packet header information based on the first configured packet header information; and
sending, by the first PF to a third PF, the packet based on a first forwarding table indicated by the data forwarding sequence.

14. The method of claim 13, wherein the first configured packet header information further indicates one or more of:
a plurality of time to live values (TTLVs) corresponding to the plurality of forwarding table IDs, each TTLV corresponding to a forwarding table ID and indicating a number of hops remaining for the packet to reach a destination of the path;
a plurality of source node IDs corresponding to the plurality of forwarding table IDs, each source node ID:
corresponding to a forwarding table ID and its associated data path; and
indicating a source node for initiating the associated data path;
a plurality of bitstrings corresponding to the plurality of forwarding table IDs, each bitstring corresponding to a forwarding table ID and indicating one or more leaf nodes of a data path associated with the corresponding forwarding table ID; or
a plurality of bitstring lengths (BSLs) corresponding to the plurality of bitstrings, each BSL defining a length of a respective bitstring of the plurality of bitstrings and each BSL corresponding to a respective FTID.

15. The method of claim 13 further comprising:
receiving, by the first PF from a control plane function, configuration information for one or more forwarding tables of the plurality of forwarding tables including the first forwarding table, wherein the configuration information for each of the one or more forwarding tables comprises one or more of:
one or more neighbor nodes for a next hop; or
forwarding bit mask (FBM) information associated with each neighbor node indicating a set of leaf nodes that can be reached via said each neighbor node, the set of leaf nodes associated with a data path corresponding to said each forwarding table.

16. The method of claim 15, wherein:
the third PF is a neighbor node indicated by the configuration information of the first forwarding table; and
the second configured header information comprises one or more of:
a result of a bitwise AND (&) operation based on:
a first bitstring of a plurality of bitstrings corresponding to the first forwarding table, and
an FBM information of the first forwarding table and associated with the neighbor node;
an updated TTL value corresponding to the first forwarding table; or
a plurality of source node IDs.

17. The method of claim 16, wherein the first packet header configuration information further indicates a first set of functions IDs identifying a first set of functions to be performed by one or more PFs of a plurality of PFs including the first PF, the first set of function IDs arranged according to the data forwarding sequence, and the method further comprises:
processing, by the first PF, data according to one or more functions of the first set of functions to obtain results, the one or more functions associated with the first PF and a first forwarding table.

18. The method of claim 17, wherein the second configured packet header information further comprises:
a second set of function IDs identifying a second set of functions to be performed by the one or more PFs, the second set of functions comprising the first set of functions and excluding the one or more functions associated with the first PF and a first forwarding table.

19. The method of claim 17 further comprising:
encapsulating, by the first PF into a payload of the packet, the results, wherein sending, by the first PF to a third PF, the packet based on a first forwarding table indicated by the data forwarding sequence comprises sending the packet including the payload.

20. An apparatus comprising:
at least one processor; and
at least one machine-readable medium storing executable instructions which when executed by the at least one processor configure the apparatus to:
send to each of a plurality of processing functions (PPFs), configuration information for one or more forwarding tables (FTs), each of the one or more FTs having associated thereto a FT identifier (ID), the PPFs defining a directed graph having a plurality of vertices and a plurality of directed edges, each vertex of the plurality of vertices corresponding to a respective PF of the PPFs, each directed edge of the plurality of directed edges corresponding to a hop of a path to be followed by processing data between a respective pair of PFs of the PPFs, the directed graph and the PPFs being associated with a network service provided by a communication network, the configuration information for each forwarding table including:
path information defining at least one path to be followed by the processing data between the PF at which the configuration information is received and another one or more PFs of the PPFs; and
send to a first PF of the PPFs, packet header configuration information including:
a plurality of FTIDs defining a sequence of the paths to be followed by the processing data when the communication network provides the network service, each FTID of the plurality of FTIDs being associated with a respective one of the one or more FTs.
